(19) United States
(12) Patent Application Publication
(10) Pub. No.: US 2024/0192658 A1
(43) Pub. Date: Jun. 13, 2024

(54) SMART COMPUTER AIDED DESIGN (CAD/CAE) SOFTWARE APPLICATION AND SYSTEM FOR DESIGNING AND MANUFACTURING ENGINEERING WORKPIECES

(71) Applicant: PARAMOUNT BED CO., LTD., Tokyo (JP)

(72) Inventor: HOAI THANH NGUYEN, HO CHI MINH (VN)

(73) Assignee: PARAMOUNT BED CO., LTD., Tokyo (JP)

(21) Appl. No.: 18/533,813

(22) Filed: Dec. 8, 2023

(30) Foreign Application Priority Data
Dec. 9, 2022 (VN) 1-2022-08080

(51) Int. Cl. G05B 19/4097

(52) U.S. Cl. CPC G05B 19/4097; G05B 2219/32335

(57) ABSTRACT

A CNC system and computer software program are operative to perform: receiving an design work; if the design work is incomplete, then using a convolutional neural network (CNN) to complete the design work and then using an auto-mode to snap fit components into the design; converting the compete design to CAD/CAE instructions; using a recurrent neural network (RNN) to create a step-by-step assembly instructions for the completed design work so as every connection of said design work is fulfilled; and assigning the completed design specification to be manufactured by a CNC machining tool in an array of CNC machining tools connected together and to the CNC system via a network.

### CLAIM OF PRIORITY

This application claims priority under 35 U.S.C. § 119(a) of the patent application No. 1-2022-08080, entitled “Phu'o'ng pháp, h [symbol] th\hat{ó}ng h\hat{õ} tr [symbol] ' thi\hat{é}t k\hat{é}, phân tích và s [symbol] n xu\hat{á}t gia công v [symbol] t li [symbol] u”, by the same inventor Nguyen, Hoai Thanh, filed on Dec. 9, 2022 in the Republic Socialist of Vietnam. The patent application identified above is incorporated in its entirety herein to provide continuity of disclosure.

### FIELD OF THE INVENTION

The present invention relates generally to the field of computer aided design (CAD) and computer aided engineering (CAE) software program. More specifically, the present invention relates to artificial intelligence (AI) based CAD/CAE software programs for designing and manufacturing engineering workpieces in different manufacturing systems.

### BACKGROUND ART

Engineering workpieces (or designs) includes components, sub-assemblies, and assemblies. Components or parts include the most basic unit of a design such as legs of a chair. Sub-assemblies include the repeated sections of a design such as doors in a house. Assemblies includes the final design such as a chair, an engine, or a house. CAD/CAE are software tools that assist designers to design engineering workpieces. After an engineering workpiece has been designed either by hands or by a CAD/CAE software program, the engineering workpiece is ready to be manufactured.

Today computerized numeric controlled (CNC) machine tools armed with smart software systems and automated processes have become ubiquitous in the industrial sector. These machine tools have eliminated the demanding and tedious labors for carpenters in their efforts to make consistent components, sub-assemblies, and assemblies. In addition, new advancement in control system and computer software has brought higher degrees of precision and automation to the designing and manufacturing tasks. This also allows increasingly sophisticated components and modularized parts to be manufactured with ease and consistency. When several workpieces must be machined with a high degree of accuracy, the uses of CNC machining tools and robotics have outperformed the manual labors of the most skillful carpenters.

Currently, the process leading to the use of CNC machining tools are usually as follows: First, engineering workpieces are designed by different CAD/CAE software such as SolidWorks, CATIA, AutoCAD, NX, Sketchlist3D, etc. More particularly, engineers or designers design an engineering workpiece such as a chair using the above listed CAD/CAE software. The final design is modeled in three-dimension (3D) to see if it meets the engineering specifications, aesthetic looking, and structural analyses required by the customers. The chair is simulated to test its mechanical characteristics including tensile strength, balance, cyclic loading performance, shear stress tests, tension stress test, compression tests, moment of inertia, and strength of materials, etc. Afterward, the design of the chair is converted into G-codes or machining codes with which the CNC machining tool cuts out different components of the chair. Finally, these components are assembled into the chair.

Today, the needs for concurrent engineering (CE) and knowledge-based system (KBS), designing and manufacturing of workpieces are incorporated together as more complex engineering workpieces are demanded. Artificial intelligence (AI) is being introduced into CNC machining tools and CAD/CAE software to reduce design time and to improve the overall design process. Neural networks are introduced into the CAD/CAE programs to provide solutions to the complexities of today design working and manufacturing tasks. To date, the solutions of the neural networks includes different stages: (1) generative design, (2) dimensionality reduction, (3) design of experiment in latent space, (4) CAD automation, (5) CAE automation, (6) transfer learning, and (7) visualization and analysis. The current AI-based framework, industrial designers and engineers can jointly review feasible 3D CAD models created by AI and select the best design for the market in the early stages of product development. In addition, because the deep learning model can predict CAE results based on 2D view design, industrial designers can obtain instant feedback regarding the engineering performance of 2D concept sketches.

In generative design, the AI optimizes structures with given parameters. In dimensionality reduction, AI transforms data from a high-dimensional space into a low-dimensional space so that the low-dimensional representation retains some meaningful properties of the original data. There exist three methods for dimensionality reduction: (a) Principal Component Analysis (PCA); (b) Linear Discriminant Analysis (LDA); and (b) Generalized Discriminant Analysis. In design of experiment (DOE) in latent space, the 2D design in the latent space is used to create CAD data. Because the latent space comprises feature vectors, the data distribution is more meaningful than the high-dimensional space. In the 3D CAD automation, the 2D design undergoes preprocessing steps: smoothing and sharpening edges, edge extraction, conversion of edges into coordinate data, and grouping of edge coordinates. Then, the 2D image and the cross-section image of the given rim are converted to 3D CAD. In 3D CAE automation, the CAE simulation data are collected using 3D CAD data. In the transfer learning, the 2D design is used as a base for deep learning model to predict the output. Finally, in the visualization and analysis, CAD/CAE engineers can visualize and explain the deep learning results to gain insights into the reliability of the results. In CNC machining applications, artificial intelligence and big data tools make CNC machining processes much more precise and way faster than they were in the past.

However, the current applications of AI to CAD/CAE and CNC machining are scattered in different software applications by different producers. They are not yet unified into a single package that can help designers and manufacturers. That is, the application of AI to CAD/CAE and that to CNC machining are not yet joined to provide a consolidated product. More particularly, as seen above, AI only helps CAD/CAE/CAM to have a faster and better final designs. In non-related applications, AI helps CNC machining tools to produce a more precise and faster final products for end-users.

Furthermore, the current applications of AI to CAD/CAM/CAE do not help engineers and designers to automatically adjust and/or maintain the dimensions of the components as those of the assemblies are changed.

The current applications of AI to CAD/CAM/CAE do not help the end-users, construction builders, and/or CNC product sellers to assemble complex engineering workpieces, wasting precious time to figure out how to assemble the components together into the whole workpiece.

Finally, the current applications of AI to CAD/CAM/CAE do not help manufacturers to select the best machine cutting tool to manufacture an engineering workpiece.

Therefore what is needed is a software program that can provide algorithms that help CAD/CAM/CAE designers and Machine cutting (MC) tools at the same time. That is, designers and manufacturers can work together on a design project from idea to final product using seamless algorithms in one unified software program.

In addition, what is needed is a software program that can use deep neural network to recommend new design ideas to designers for faster and more efficient design processes.

What is needed is a software program that can predictively complete an incomplete design for designers.

What is needed is a software program that can automatically adjust the dimensions of the component parts when the dimension of the whole engineering workpiece is adjusted.

What is needed is a software program that uses recurrent neural network (RNN) to provide a step-by-step action assembly instructions to manufacturers.

What is needed is a software program that has the ability to find the best CNC machining tools to manufacture a design, and then assign that design to that particular CNC machining tool.

The software program and networked CNC system of the present invention solve the above described problems and provide all the above needs to the customers.

### SUMMARY OF THE INVENTION

Accordingly, an object of the present invention is to provide a CNC system and computer software program which are designed to perform the following tasks: (a) receiving an design work; if the design work is incomplete, then using a Recurrent Neural Network (RNN) recommendation unit to complete the design work and then using an auto-mode to snap fit components into the design; (b) converting the compete design to CAD/CAE instructions; using a recurrent neural network (RNN) to create a step-by-step assembly instructions for the completed design work so as every connection of said design work is fulfilled; and (c) assigning the completed design specification to be manufactured by a CNC machining tool in an array of CNC machining tools connected together and to the CNC system via a network.

An object of the present invention is to provide a CNC system which comprises: a CNC module operative to provide a graphic design interface where an design work are completed using a CAD/CAE manual mode and/or a smart mode; at least one processing units electrically coupled to operate different CNC modules; and at least one memory device operative to store the parameters of the CNC modules and a trained dataset whereby the feature detection of the recurrent neural network (RNN) is configured to provide step-by-step assembly instructions of the complete design work.

Another object of the present invention is to provide a computer numerical control (CNC) machining apparatus which comprises: a first base; a second base vertically perpendicular to the first base; a tool head support assembly having a tool head, connected to and move a tool head in an omni-direction; and a plurality of rotatable clamps configured to independently hold, release, and move a workpiece along the first base and independently rotate a workpiece 360° around itself.

Yet another object of the present invention is to provide a method of providing CNC machining that includes independently holding and releasing a workpiece using a plurality of rotatable clamping devices controlled by the CNC machining apparatus; moving the workpiece linearly by independently holding, releasing, and moving the plurality of rotatable clamping devices which are numerically controlled by the CNC machining apparatus; and rotating the workpiece 360° around itself to a side where the specification design requires.

Yet another object of the present invention is to provide a convenient smart-mode which snap-fits a component into a total design.

Yet another object of the present invention is to provide a CNC system and software programs that can provide seamless applications to designers from designing to manufacturing using deep learning networks including c recurrent neural network (RNN).

These and other advantages of the present invention will no doubt become obvious to those of ordinary skill in the art after having read the following detailed description of the preferred embodiments, which are illustrated in the various drawing and figures.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is an overview of the software application program including five main functions such as (a) training a hybrid recurrent and convolutional neural network using a specialized dataset; (b) drawing an design work using either a manual node or a RCNN-based smart mode; (c) predicting and recommending new design works, (c) using the RCNN to perform an automatic counteraction algorithm, (c) using the RCNN to perform a smart fitting algorithm, (d) using the RCNN to perform to create assembly instructions with bill of materials (BOM), and (e) using the RCNN to perform to perform smart manufacturing by selecting of the best CNC machines to manufacture a particular components in accordance with an exemplary embodiment of the present invention;

FIG. 2 is a system schematic diagram of general architecture of the smart CAD/CAE system configured to perform the tasks described in FIG. 1 in accordance with an embodiment of the present invention flow chart describing a manual mode operation of the graphic area (design work interface “EDI”) in accordance with an embodiment of the present invention;

FIG. 3 is a perspective diagram illustrating an arrangement of the design interface and its menus in accordance with an exemplary embodiment of the present invention;

FIG. 4 is an architecture of the recurrent convolutional neural network (RCNN) in accordance with an exemplary embodiment of the present invention;

FIG. 5 shows an architecture of the recurrent neural network (RNN) in accordance with an embodiment of the present invention;

FIG. 6 shows a process of training and testing the RCNN to realize the present invention illustrated in FIG. 1;

FIG. 7 is a flow chart describing an analytical flow direction of the RCNN in accordance with an embodiment of the present invention;

FIG. 8 is a flow chart describing an auto-mode of the design work at the sub-assembly and assembly level that provides smart-fitting in accordance with an embodiment of the present invention;

FIG. 9 is a flow chart of the RCNN-based smart mode for predicting and completing an design work in accordance with an embodiment of the present invention

FIG. 10. is a flow chart describing different input sources of design work imported into the graphic area (design work interface) in accordance with an embodiment of the present invention;

FIG. 11 illustrates a flow chart of component level analytical methodology in accordance with an embodiment of the present invention;

FIG. 12 is a flow chart of a smart fitting algorithm at the sub-assembly and assembly level in accordance with an embodiment of the present invention;

FIG. 13 is a flow chart of a joint counteraction algorithm in accordance with an embodiment of the present invention;

FIG. 14 is a flow chart of an assembly instruction algorithm in accordance with an exemplary embodiment of the present invention;

FIG. 15 is a flow chart of a smart manufacturing algorithm in accordance with an exemplary embodiment of the present invention;

FIG. 16 is a 3D perspective diagram illustrating component analysis and smart fitting features of the Recurrent Neural Network (RNN) in accordance with an embodiment of the present invention;

FIG. 17 is a 2D perspective diagram illustrating a smart fitting feature of the Recurrent Neural Network (RNN) in accordance with an embodiment of the present invention in accordance with an embodiment of the present invention;

FIG. 18 illustrates features of the RCNN for a design work such as a chair in accordance with an embodiment of the present invention;

FIG. 19 illustrates the component analysis and joint automatic counteraction of a component including a body part and a connector part in accordance with an embodiment of the present invention;

FIG. 20 illustrates a 3D perspective diagram of an assembly instruction of an design work such as a chair in accordance with an exemplary embodiment of the present invention;

FIG. 21 is a 3D perspective diagram of a CNC machine tool networking with other CNC machining tools having different capabilities in accordance with an exemplary embodiment of the present invention;

FIG. 22 is a hardware architecture of the AI-based CNC system in accordance with an exemplary embodiment of the present invention

The figures depict various embodiments of the technology for the purposes of illustration only. A person of ordinary skill in the art will readily recognize from the following discussion that alternative embodiments of the structures and methods illustrated herein may be employed without departing from the principles of the technology described herein.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Within the scope of the present description, the reference to “an embodiment” or “the embodiment” or “some embodiments” means that a particular feature, structure or element described with reference to an embodiment is comprised in at least one embodiment of the described object. The sentences “in an embodiment” or “in the embodiment” or “in some embodiments” in the description do not therefore necessarily refer to the same embodiment or embodiments. The particular feature, structures or elements can be furthermore combined in any adequate way in one or more embodiments.

Within the scope of the present description, the word “omni-direction” means all directions of a spherical coordinate covering the same space of the Cartesian XYZ coordinates system 899. The X-direction and Z-direction translational (or linear) movements, the rotational Y-direction and Z-direction of the head tool assembly; the Y-direction translational movements, and the rotation 360° around the Y-axis enable CNC machining apparatus 800 to approach from any angle and operate precisely at any location regardless of the proximity of these points on workpiece 821.

Within the scope of the present description, the words “connected”, “connecting”, “coupled”, “coupling”, “connections”, “coupled”, “bolted”, “laid”, “positioned”, “attached”, “attaching”, “affixed”, “affixing” are used to mean attaching between two described members using screws, nails, tongs, prongs, clips, spikes, staples, pins, male and female nuts, buttons, sleeves, lugs, cams, handles, bars, fasteners, connectors, or the likes.

Within the scope of the present description, the words “connected”, “connecting”, “coupled”, “coupling”, “connections”, “coupled” are used to mean wired and/or wireless connections. Wired connections include electrically conducting wires, cables, lines, coaxial cables, strips, or the likes. Conducting wires are made of conductors such as coppers, aluminum, gold, or the likes. Wireless connections include electromagnetic waves, short range communication channels include ZigBee™/IEEE 802.15.4, Bluetooth™, Z-wave, NFC, Wi-fi/802.11, cellular (e.g., GSM, GPRS, WCDMA, HSPA, and LTE, 5G, etc.), IEEE 802.15.4, IEEE 802.22, ISA100a, wireless USB, and Infrared (IR), LoRa devices, etc. Medium range wireless communication channels in this embodiment of communication link 161 include Wi-fi and Hotspot. Long range wireless communication channels include UHF/VHF radio frequencies.

Within the scope of the present description, the word “network” includes data center, cloud network, or network such as nano network, body area network (BAN), personal area network (PAN), local area network (LAN), campus/corporate area network (CAN), metropolitan area network (MAN), wide area network (WAN), and mesh area networks, or any combinations thereof.

Within the scope of the present description, the word “rotation”, “rotating”, “rotate” includes clockwise and/or counterclockwise direction.

Within the scope of the present invention, the word, “design work” includes a workpiece, a component, a sub-assembly, or an assembly to be designed and manufactured by a CNC machine.

Within the scope of the present invention, the Cartesian XYZ coordinate (x,y,z) also includes equivalent spherical coordinate (r, θ, ϕ), and/or cylindrical coordinate (r, θ, z) that can determine the direction of movement or coordinate of a point of any members of CNC machining apparatus.

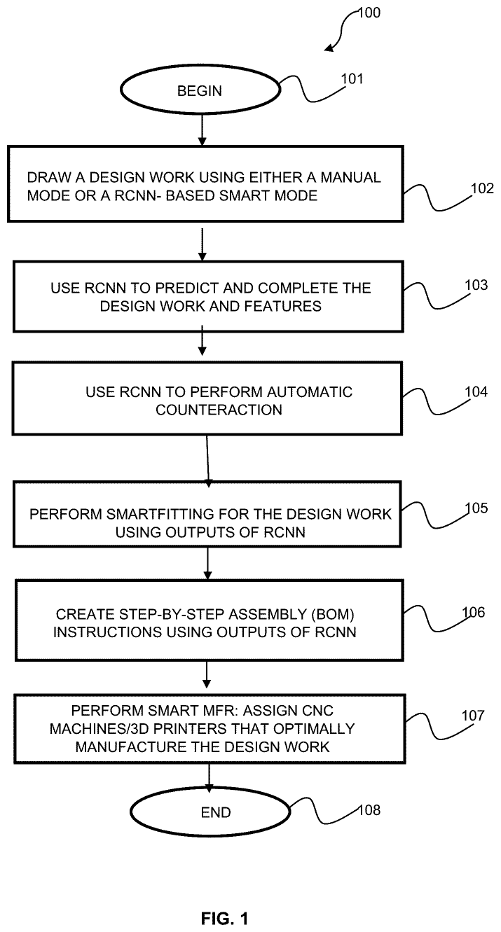

Referring now to the drawings and specifically to FIG. 1, a flow chart of a software application program 100 operative to provide a recurrent convolutional neural network (RCNN) based design work tool and to control an array of Machine cutting (MC) tools via a network in accordance with an exemplary embodiment of the present invention is illustrated. Software application program 100 provides a recurrent convolutional neural network (RCNN) based design work tool and a network control of an array of CNC machining tools via a network. That is, software application program 100 is capable of recommending and completing component parts of a design work during a design process using RCNN algorithms. Consequently, after the design work is completed with the aids of recurrent convolutional neural network (RCNN), application program 100 converts graphic design work into computer aided design (CAD) instructions and then to a machine language that all CNC machining tools can understand and operate upon.

Finally, application program 100 uses this machine language to select best CNC machining tool among a network of CNC machining tools to manufacture a particular design work or a component of an design work. FIG. 1 presents an overview of six main functions of software application program 100. These main functions, among other functions, include (1) start a manual and/or smart mode on a graphic area; (2) recommend or complete an design work; (3) determine the relationship among components of an design work including automatic counteracting and smart fitting; (4) generate a step-by-step assembly instructions and a bill of materials (BOM); (5) model, simulate, and test the complete design work; and (6) select the best CNC machining tool to manufacture a particular design work or a component among a network of CNC machining tools.

More particularly, at step 101, application program 100 is started. In many embodiments of the present invention, step 101 is realized by a microprocessor (CPU) starting software application program 100 when users initiate an icon or a graphic user interface (GUI) on a desktop of their communication devices. In various implementations of step 101, application program 100 is a software application embodied in graphic user interface (GUI) or an icon on the display of a communication device. Users can start step 101 by clicking on this GUI or icon. Alternatively, step 101 can be implemented by accessing a worldwide web (www) address. Application program 100 is embodied in a webpage. After the icon is clicked, all operating files that support software application program 100 are loaded. After the webpage is displayed, designers log-in in order to use software application program 100. In some embodiments of the present invention, the designers have to go through 2 step authorization process that include username and password. In other embodiments, the designers can log in using barcode, QR code, RFID, bio-metrics such as fingerprints, iris recognition and pupil scanners.

Before using step 101, a hybrid recurrent convolutional neural network (RCNN) is trained to perform the above tasks or functions. First, a special CNC dataset including 81 different types of joints (please see Table 1), components (chair legs), sub-assemblies (a wall of a house), and assemblies (a house or a chair) manufactured by CNC machining tools and 3D printers are collected. This CNC dataset includes labeled images of furniture, tools, residential houses, and office building, and their components thereof. Each component—a smallest unit—includes at least one joints to interconnect to sub-assembly and assembly. Each image picture in the CNC dataset has a size 227×227×3. Initially, the CNC dataset of the present invention includes 500.000⁺ images of joints, furniture, houses, buildings, and their components collected from ImageNet with additional 81 different joint types. The 81 different joint types are divided into 8 different classes: biasing joints, cross joints, T-joints, corner L-joints, oblique joints, coplanar joints, flexures, special or new joints that do not belong to the previous 7 classes.

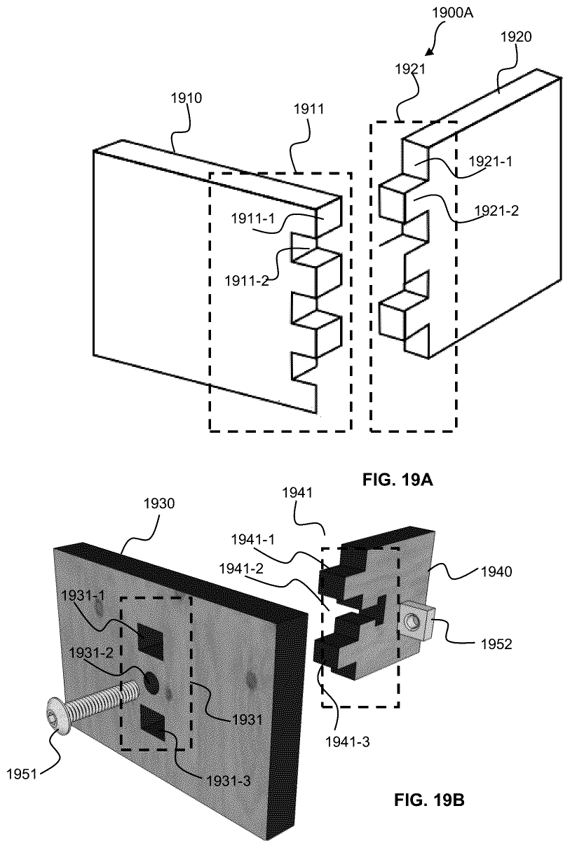

The novel CNC dataset is loaded into a RCNN of the present invention for training and testing. After training and testing, the RCNN of the present invention recognize a component j with its joints, and then recommend the next components j+1, j+2, etc. with complementary joints that mate with the component j. Please refer to FIG. 19A and FIG. 19B for clarification. Due to the complexity and infinite variety of joints, the RCNN of the present invention is trained to memorize and recognize the component j, its joints, and its mating components j+1, . . . , j+N. That is, if any of the components in the sequence j, j+1, . . . j+N and their respective joints are known, the RCNN of the present invention recommends the remaining components and their joints by the memories of the recurrent neural network.

Continuing with step 101, In various embodiments of the present invention, the architecture of the RCNN of the present invention

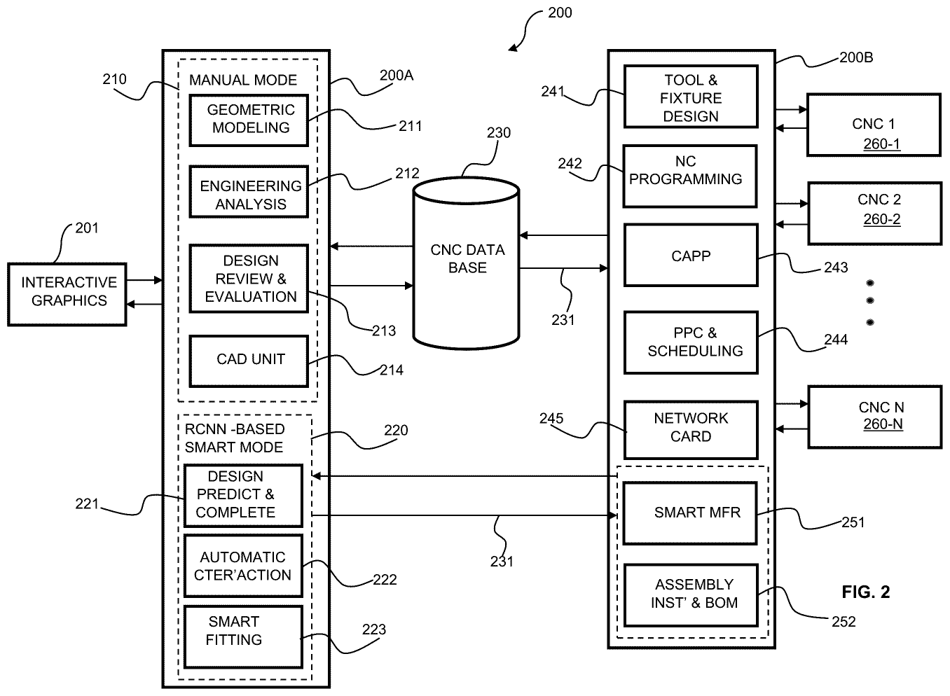

At step 102, a graphic area (also known as design work interface (EDI), drawing panel, or any display section dedicated to draw and complete a design work; please refer to FIG. 2) is displayed that enables a designer to start designing an design work or an engineering workpiece. The complete and final design work are used to generate engineering codes and/or specifications (e.g., BOM and assembly instructions) for CNC manufacturing later on. Step 102 is realized by computer graphics interface or graphic area similar to those of the prior-art CAD/CAM/CAE software such as Abacus, Altair, Ansys, Fusion 360, AutoCAD, MATLAB, and SolidWorks, C3D Viewer, C3D tool, etc. The graphic area of step 102 is used to draw lines, curves, arcs, sketches, threads, fillets, chamfer, bevel, spline, rib, shell, and wraps that form components, sub-systems, and systems. A possible arrangement of the graphic area of step 102 is shown and discussed in more details in FIG. 2.

Next at step 103, an instance of a design work is predicted or recommended using recurrent convolutional neural network (RCNN). While a designer is drawing the current design work, the step 103 of the present invention uses RCNN algorithms to predict and/or complete (1) the current design work including the wooden part and the connection (joinery) part or (2) other components or sub-assemblies that will be connected to the current design work. More particularly, step 103 is fructified by a smart mode realized by recurrent convolutional neural network (RCNN) algorithms that automatically recommend and/or predict any components, sub-assembly, or even the entire design work. More particularly, the RCNN uses its feature detection capability to classify a component (i.e., hind legs of a chair) including its wooden part and a joinery part. The RCNN uses its sequential processing of data to recommend the assembly order and the bill of materials (BOM) of the design work. Such RCNN may include Long-Term Short Term (LTSM) system, gated recurrent unit (GRU), LSTM with attention, multiplicative LSTM, and peephole LSTM, etc. The RCNN is capable of recognizing imported images of a workpiece from other users' databases via a network such as the cloud network, from social media such as Facebook, from the Internet such as Google. Computer vision algorithms recognize the workpiece and translate it into a design work specification. The detailed features of the graphic area (EDGI) will be described in FIG. 2 to FIG. 6. The training, testing, and operations of CNN and RNN will be discussed in details in the present Specification.

At step 104, a smart-mode in the graphic area allows the designer to complete the design without having to enter trivial components or sketches. In some features of method 100 of the present invention, the smart mode of step 104 can classify a component including a detecting a wooden part and connection parts and then presenting the automatic counteraction. Automatic counteraction includes geometry, dimension, number of wooden parts, types of joints (e.g., basic butt), number of joints, locations of joints, and angle of insertion—these are features that are detected by different filters of CNN algorithms except dimensions. For example, if the current component has a basic butt joint, the recommended component presented by the RNN is another component that has the same dimension and connection (joinery) that mates with the basic butt. Other features of step 104 include smart fitting. In the smart fitting, the dimensions of new components of a workpiece will be automatically adjusted if the distances of the other components to which the newly designed components are known. It is noted that design work specification includes styles, dimensions, colors, connection type, connection angle, plane of connection, etc.—parameters that allows an ordinary skill carpenter and any computerized numeric control (CNC) machine tools to reproduce the workpiece. Most programming languages such as Python, C++ have built-in subroutines for measuring dimensions and lengths of objects such as “object_size.py” in Python.

At step 105, a step-by-step assembly instructions are created using Recurrent Convolutional Neural Network (RCNN). Relationships between design works are created using recurrent neural network (RNN) algorithms. It is well known that RNN such as LTSM and GRU include internal memories that can handle sequential input. Inputs such as, but not limited to, carpentry, furniture, automobile parts, etc. are used to train the RNN and CNN. The RNN/CNN infrastructure with at least 5 hidden layers and 5×5 convolutional filters are built. The internal memories of the RNN are used to store different components and their coordinates of the design. Thus, RNN algorithms are used to construct the assembly instruction without missing a single component or connector.

At step 106, after completion, the design specification is converted to CAD/CAM/CAE format which can be simulated, solid modeled, tested, ran other engineering analyses such as finite element analysis (FEA). Step 106 is realized by a CAD/CAE compiler using object-oriented software, ICAD Design Language (IDL), and LISP programming language. Within the scope of the present invention, whenever CAD/CAM/CAE is referred to it also includes computer aided design (CAD), computer aided engineering (CAE), computer assisted manufacturing (CAM) and/or other computer aided software programs. Step 106 also includes translating the complete design work specification into a machine language. The machine language can be G-code (CS-274), M-codes, and other variants configured to control an array of CNC machining tools.

Next at step 107, an array of Machine cutting (MC) tools are controlled by RCNN algorithms to manufacture the design works. In many embodiments, the array of Machine cutting (MC) tools are connected together via a network such as a cloud-network. One hidden layer of the RNN/CNN is trained to store the characteristics of each CNC machining tool. The RNN/CNN network uses the characteristics of the CNC machining tools and the design to find the best CNC machining tool to cut a particular component of the design. For example, the Omni-directional CNC machining tool as disclosed in a parent application entitled, “Omni-directional Computerized Numerical Control (CNC) Machine Tool and Method of Using and Performing the Same” by Hoai Thanh Nguyen, application Ser. No. 17/305,053, filed on Jun. 29, 2021. In some embodiments, application program 100 is a computer software program stored in any CNC machine tool of the array that control other Machine cutting (MC) tools via the network or in a master-slave fashion.

It will be noted that in some aspects of the present invention, a manual mode similar to SolidWorks, CATIA, AutoCAD, etc. by which the designers manually design the complete design can be used instead of the recommendation of the RNN/CNN and auto-mode as described above.

Thus, software application program 100 achieves the following objects of the present invention:
(a) an auto-mode which snap-fits a component into a design, which includes automatically adjusting the dimensions of components or sub-assemblies to fit into an assembly as the dimension of the assembly has changed.
(b) a seamless design process which provides complete assistance to designers from designing to manufacturing using deep learning networks including convolutional neural network (CNN) and recurrent neural network (RNN).
(c) a recommendation system that helps the designers to complete a design idea from scratch based on object segmentation and identification of the RNN/CNN.
(d) an infrastructure that produces a step-by-step assembling instructions using internal memories and consequential data processing of the RNN.
(e) a smart system that can select the best CNC machine or 3D printer to print an design work.

Referring to FIG. 2, a system diagram representing an overview of a smart CAD/CAE/CAM system 200 (hereinafter referred to as “smart system 200”) designed to perform method 100 in accordance with an exemplary embodiment of the present invention is illustrated. Smart system 200 includes a design sub-system 200A, a CNC database 230, and a manufacturing sub-system 200B. Design sub-system 200A is coupled to an interactive graphics 201. Within design sub-system 200A, there are a manual mode module 210 and a recurrent based smart mode 220. Manual mode module 210 includes a design unit 214, a design and review evaluation 213, an engineering analysis unit 212, and a geometric modeling unit 211. Design unit 214 generates design work interface (EDI) which includes interactive graphic 201. Design and review evaluation unit 213 allows a designer to finalize and change a design work, which is part of EDI. Engineering analysis unit 212 performs analyses for a complete and finalized design work, which includes structural analyses, finite element method (FEM), simulation, cyclic loading performance, etc. Geometric modeling unit 211 uses mathematics and computer graphics to design a design work. There are three main steps involving in the modeling process: step 1 is to create a basic geometric object using points, lines, curves, etc. Step 2 transforms geometric elements as desired using scaling, rotation, and translation. Step 3 integrates elements of the object to create the final geometric model. In various embodiments of the present invention, design unit 214 is implemented by computer aided software engineering (CASE) tools.

Still referring to FIG. 2, manufacturing sub-system 200B includes a tool & fixture design unit 241, a NC programming unit 242, a CAPP unit 243, a PPC & scheduling unit 244, a network card 245 connecting different CNC machining tools such as a first CNC1 2601-1, a second CNC2 260-2, and an nth CNCN 260-N. It is noted that any of these CNC1 260-1 to CNC2 260-N can be laser cutters and 3D printers. Tool and fixture unit 241 contains resources for designing jig, fixture, dies, electrodes, and molds. These are special designing tasks require different manufacturing methods numeric control (NC) programming unit 242 translates new design works into machine codes. Computer Aided Process Planning (CAPP) unit 243 ensures a smooth transition from the design work to computer aided manufacturing (CAM). Production & Planning Unit (PPU) & Scheduling 244 involves six different steps 1) release order; (2) assign work to work centers (3) sequencing priority jobs; (4) control manufacturing lead time; (5) monitor priority status; and (6) monitor capacity status.

These standards unit 241-244 handshake with smart manufacturing unit 251 and assembly instruction with bill of materials (BOM) 252 which are two novel units of the present invention. Smart manufacturing unit 251 communicates with CAPP unit 243 and PPC scheduling unit 244 to assign a new design work to an CNC machining tool among CNC1 260-1 to CNCN 260-N that best manufacture that design work. In addition to common factors of PPC & scheduling unit 244 such as total times, the novel decision to assign is based on the geometrical shape of the design work. For example, first CNC1 260-1 is specialized in working on a large surface area components such as a seat of a chair while CNCN 260-N is specialized on long and thin components such as legs of a chair.

In many instances of the present invention, seats will be assigned to first CNC1 260-1 and the chair legs are assigned to nth CNCN 260-N. Assembly instructions & BOM unit 252 communicates with the memories and attention mechanism of a recurrent convolutional neural network (RCNN) of design predict and complete unit 221 to produce an action assembly plan that shows the end-users how to assemble the design work assemblies. CNC database 230 contains design works, images, NC codes, and features. CNC database 230 communicates with computer aided design unit 200A and CAM sub-assembly 200B via communication links 231. In many aspects of the present invention communication links 231 are electrical copper wires, thru-hole leads, wireless channels, and the likes.

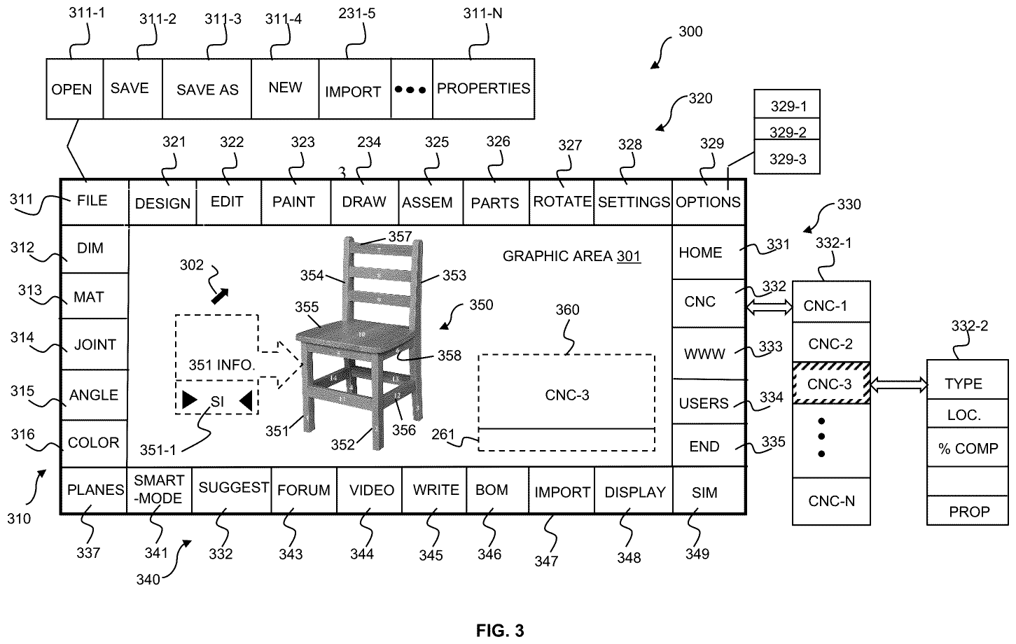

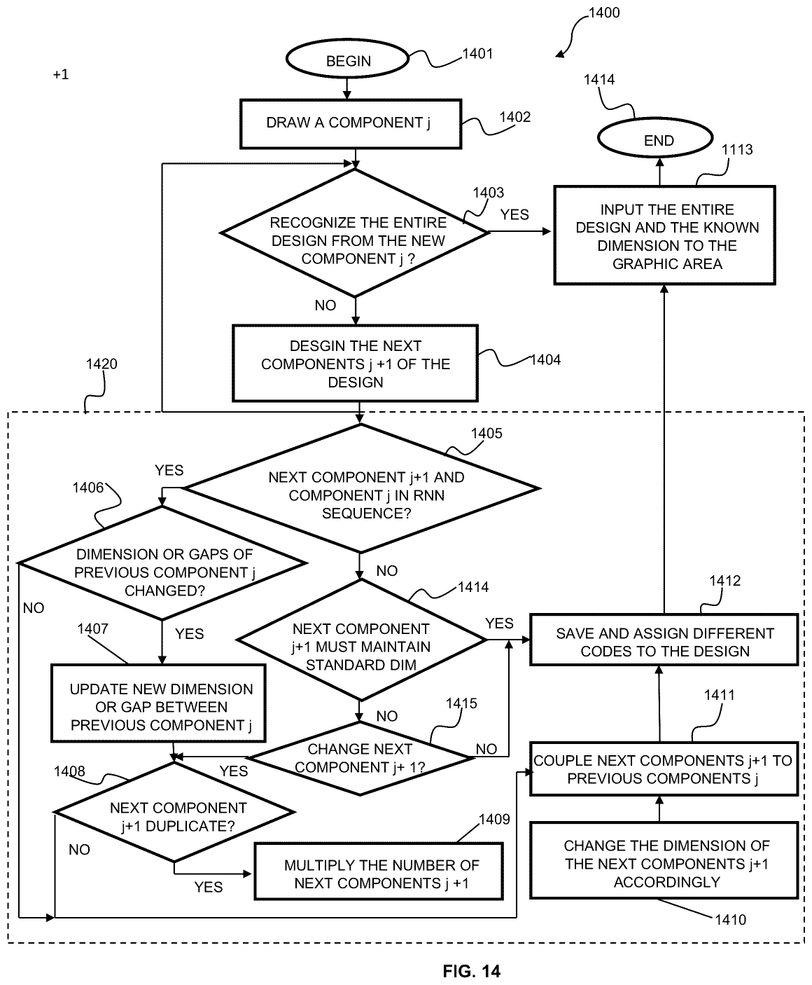

Continuing with FIG. 2, computer aided design sub-system 200A also includes RCNN-based smart mode module 220 includes a design predict and complete unit 221, an automatic counteraction unit 222, and smart fitting unit 223. RCNN-based smart mode module 220 is essential to the present invention. Design predict and complete unit 221 includes mainly convolutional neural network (CNN) layers designed to identify different portions of design work to extract features such as dimension, coordinates, shapes, joint types, main body section, and number and locations of joints. The recurrent neural network (RNN) is designed to keep track of the connection sequences as well as the part list of an design work. The RNN and RNN are combined into a novel hybrid RCNN designed to perform method 100 above. The architecture, training, testing, and mathematics of the hybrid RCNN dedicated to Machine cutting (MC) tools are described in details in FIGS. 3-FIG. 22 below.

Now, referring to FIG. 3, a perspective diagram of an design work interface (EDI) 300 that realizes step 102 in accordance with an exemplary embodiment of the present invention is illustrated. Generally, EDI 300 comprises tool bars including tools 311 to 349 arranged around the perimeter of a design area 301. Design area 301 displays the design work specification such as an exemplary chair 350. A cursor 302 is used to place components of chair 350 together. Alternatively EDI 300 is also referred to as task pane 300.

The following are some exemplary function menus of EDI 300 includes, but not limited to, the followings: (1) a first toolbar 210 includes a file 311, a dimension 312, material 213, connection or joints 314, angle 315, color 316, plane 317; (2) a second toolbar 320 includes: a design 321, edit 322, paint 323, draw 324, assemblies 325, parts or sub-assemblies 326, rotate 327, setting 328, and options 329; (3) a third toolbar 330 includes: home 331, CNC 332, worldwide web 333, users 334, end 335; and (4) a fourth toolbar 340 includes: a smart-mode 341, recommendation 342, forum 343, video 344, users 345, Bill of Materials (BOM) 346, finite engineering 347, instructions 348, and setting 349. It is noted that the arrangement presented above is only a non-limiting example of how EDI 300 is arranged. Other arrangement of look-and-feel of EDI 200 is also within the scope of the present invention.

File 311 menu is a drop-down menu including sub-functions grouped together such as opening previous files 311-1, save 321-2, save as 311-3, import 311-4 and properties 311N which include the information about the current file. Dimension 312 is operative to add length, width, surface, and a user coordinate system (UCS). Material button 313 allows users to specify materials to an design work 350 including different types of woods, aluminum, etc. Joinery 314 specifies joints for connecting components such as screws, threads, male-female, tail board and pin board, basic butt, tongue groove, mortise and tendon, half-lap, mitered butt, biscuit joint, rabbet joint, half blind dovetail, finger joint, back-face, and sliding dovetail. Please see Database listed below in Table 1.

In many embodiments of the present invention, dimension 312 and joinery 315 can be predicted and automatically provided given the total dimension of the assembly such as chair 250 is known. For example, if the dimension of seat 355 is enlarged, the lengths of cross stretchers 356 are automatically adjusted accordingly. Angle 315 provides the cut angles for the joints such as in the tail and pin of the tail and pin board. Color 316 provides palette colors to design work 350. Plane 317 specifies the relative planar positions between different parts, cuts, or surfaces of design work 350, or even those of the same component level. By virtue of plane 317 and angle 315, complex design work 350 and joints such as chamfers, fillets, and bevels can be designed. Design 321, when activated, the manual mode is enabled throughout the design process for design work 250. In some embodiments of the present invention, design 321 when clicked again (or twice) would turn off the manual mode and activate the smart mode. Alternatively, smart mode 341 can be clicked to turn off manual mode and start the AI-based recommender. Edit 322 is an amendatory tool to allow designers or users to make changes to design work 350 especially after the smart mode 341 is used. Paint 323 displays a dialog box with different color palettes and paint brush sizes, nips, and tips that allow users to decorate design work 350. Similarly, draw 324 allows the designer to draw design work 350 at either assembly level or component level. Assembly 325 enables designers to sketch at the system level such as the chair. On the contrary, parts 326 allow designer to draw at the part or component/sub-assembly level such as front legs 351 and 352. At either level—assembly 325 or parts 326—smart mode 341 recommends new design works at the appropriate level. Rotate 327 uses a cursor 302 to select and capture design work 350 to rotate it 360° in 3D space of design area (or graphic area) 301.

Alternatively, if the designer starts at the component level, then rotate 327 rotates the component being designed such as front leg 351 instead of the whole design work 350 of the chair. Settings 328 function to display different sets of tools for second toolbar 3220. Options 329 specify generation system options such as enabling the performance feedback option 329-1 and the Confirmation Corner 329-2. In addition, options 329 can display standard toolbar or special toolbar. In addition, feedback option 329 also include setting the number of documents last opened. When the present software is restarted automatically opens the documents that were open when last exited from the present software. The special tool bar of options 329 may also include a block section 329-3 designed to select either whole or a part of design work 350. In a non-limiting application of block 329-3, when components such as the supporting legs of design work 350 are repetitive such as one leg 351-354 of design work (e.g., chair) 350. Editing one leg 351 by selecting 225-1 will automatically edit other legs 352-354.

In some embodiments, blocks of design work imported from elsewhere can be worked on by virtue of block 326. Rotate 327 allows users to look at design work 350 from different views and angles: top view, bottom view, side views, and rear view so as to facilitate the designing process. Setting 328 opens a dialog box enabling users to change the structure, color, function, touch and feel of design work interface (EDI) 300. Machine language code 329 is used to compile and view the codes of design work 350 after the design is completed. Users may edit these codes to edit the design displayed on an auxiliary screen 360.

Continuing with FIG. 3, in one exemplary embodiment of the present invention, a bottom horizontal tool bar 340 of EDI 300 is comprised of the artificial intelligent functions such as smart-mode 341, suggest 342, forum 343, video 344, write 345, bill of materials (BOM) 346, an import 347, display 348, and simulation 349. When smart-mode 341 is executed, artificial intelligence (AI) features start, assisting the manual mode. That is, machine learning algorithms of the present invention provide either part or the entire design when designer enter the design requirements in form of either voice command, images, written description, and partial designs. Suggest 342 recommends the design work specification based on preference, search, purchase, and/or view history of a user or group of the same users. Forum 243 allows the users to chat with one another exchanging design ideas and problems. In some embodiments, suggest 342 uses the chat record to recommend a design discussed in chat 343. Similarly, video 344 when clicked on will allow a user to view the manufacturing process of a particular CNC machine tool (CNC-1 to CNC-N) when the user selects a particular CNC machine tool using CNC 332.

Often, at the beginning of the design process, a user does not have clear idea about a design. In this situation, this user can use write 345 to jot down his/her initial ideas. Then use suggest 342 to view an initial design on design area 301. Rotate 327, edit 322, and select 325 can be used to achieve a better idea of the design. Audio 326 is another method to record the design idea and suggest 342 to provide an design work specification. As a non-limiting example, when a user uses audio 346 to provide a chair with a back support and four legs. A voice recognition algorithm of auto-mode 341 translates this voice command into codes. Based on this information, suggest 342 uses machine learning algorithm to provide design work 350.

In another situation, import 347 allows users to import images of workpieces such as design work 350 from the world-wide-web, local databases, network-databases, and social media. Computer vision algorithms of smart-mode 341 recognize these imported images and convert them into codes that can display on design area 301. Display 348 provides visual information to users to increase efficiency. Some non-limiting examples of display 348 includes auxiliary display panel 360 inside graphic area 301. When the users select CNC 332, a menu 332-1 displays all CNC machines tools that are in communication with design work interface 300. As the users select one Machine cutting (MC) tools, e.g., CNC-3, display 260 displays the real-time manufacturing process of that CNC-3. Tool bar 361 provides the setting for display 360 such as color, angle of view, resolution, and operations (i.e., slow motion, forward, reverse, play, stop, save), etc. In another example, when the users select a component 325-1 of workpiece 350, smart-mode 241 uses machine learning algorithms to find the most efficient CNC that can manufacture that support leg. The most efficient CNC machine tool, e.g., CNC-3 will be assign to manufacture the selection 325-1. Evidently, the real-time manufacturing of selection 325-1 can be seen on display 360. Finally, simulation 349 provides engineering analyses including finite of design work 350 including forces, torques, materials, joints, balance, etc. The graphs and numerical results of this simulation can be displayed on display 360.

Continuing with FIG. 3, home 331 returns the designer to the present display screen. As alluded before, CNC 332 when selected will provide the list of all Machine cutting (MC) tools CNC-1, CNC-2, to CNC-N that are in communication with the present EDI 300. The world wide-web 333 allows the designer to search the web for their favorite designs. Designers 334 displays all users that are currently connected to EDI 300 via a network. End 335 stops the simulation or search processes.

Design work Interface (EDI) 300 described above is only an exemplary embodiment that provides the smart-mode employing machine learning and computer vision algorithms in the design process. As such the following objects are achieved:
(1) The design complexities are reduced, saving time for other tasks;
(2) Efficient manufacturing process is achieved by connecting and assigning the best Machine cutting (MC) tools for the job among the array of Machine cutting (MC) tools from different locations.

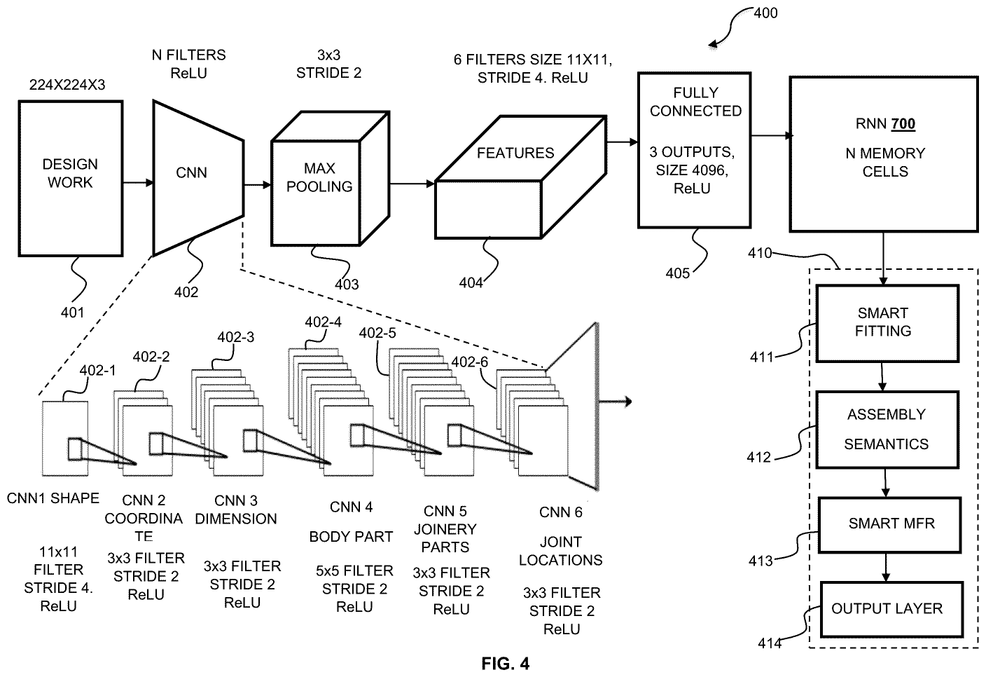

Now referring to FIG. 4, the architecture of a recurrent convolutional neural network (RCNN) 400 that is the core support of method 100 and methods 800-1500 is illustrated. Convolutional neural network (CNN) layer 402 receives and looks for specific features from an design work 401. In many embodiments of the present invention, CNN layer 402 further comprises six filters of size 11×11 and stride 4. These six filters 402 are a coordinate filter 402-1, a shape or geometry filter 402-2, a dimension filter 402-3, a body part filter 402-4, joint type filters 402-5, and joint location filters 402-6.

In other embodiments, there are filters for classifying significant parts and non-significant parts. Significant parts are components of a design work. Insignificants parts are screws, fasteners, tak pins, wood dowels, aluminum coupler, lock, and locking braces—any mechanical means that assist in securing components together into a sub-assembly or assembly. Outputs of CNN layer 402 are fed into a max pooling module 403. Max pooling module 403 performs pooling operation that calculates the maximum value for patches of a feature map, and uses it to create a down sampled (pooled) feature map. Max pooling module 403 adds a small amount of translation invariance—meaning translating input design work 401 by a small amount does not significantly affect the values of most pooled outputs. Next, the pooled outputs then input into fully connected layer (FC) 404. In many embodiments of the present invention, FC layer 404 (also known as hidden layer) contains six fully connected layers which receive six input features from max pooling layer 403 to output three different probability distributions for assembly, sub-assembly, and components.

Next, RNN layer 700 sequentially receives component-level input from FC layer 405 and predicts the next component with automatic counteraction. The outputs of RNN 700 is passed through an output stage 410 which further includes a smart fitting module 411, an assembly instructions module 412, and a smart manufacturing module 413. Output stage 410 is essentially based on RNN 700. Smart fitting module 411 decides whether to automatically change the dimensions of directly connected components when the designer has changed the dimensions of the associated sub-assemblies or assemblies. Those components are not directly connected and/or must meet construction requirements are kept the same. Assembly semantic module 412 receives the sequence of components from RNN 700 and performs blocking, plane, and distance analyses in order to output an action assembly instructions for the end-users. Smart manufacturer module 413 obtains the final dimensions and shapes of each component and match them with the parameters of different cutting tools using Euclidean distance analysis. The attributes of each component and a cutting tool are mapped into vectors or tensors. Then they are compared using Euclidean distance. If the distance is near zero, then that component is assigned to that cutting tool. Otherwise, the component is assigned to a different cutting tool that has the smallest Euclidean distance. Finally, the component sequence that makes up a final design, action assembly, and cutting tool assignment are output into an output layer 414.

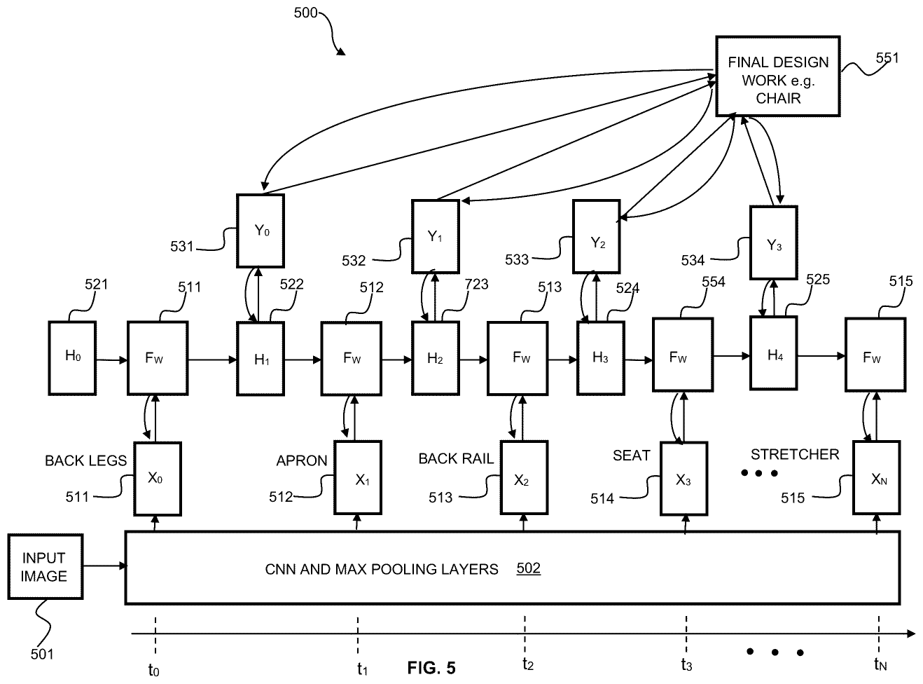

Next, referring to FIG. 5, an architecture of recurrent neural network layer (RNN) 700 in accordance with an exemplary embodiment of the present invention is illustrated. As alluded earlier, an input image 501 is passed through a CNN and max pooling layer and FC layer 502 to extract the components and attributes. Each time, CNN and max pooling with FC layer 502 outputs a component which is the smallest unit with joints. These components are connected together to form the final product. Components with joints may be a leg of a chair or a pre-fab wall unit. The pre-fab wall unit with connectors can connect to other pre-fab walls to form a house. For example, at time to, layer 502 outputs a first component X₀ in a memory cell 511. At time t₁, layer 502 outputs a second component X₁ in a memory cell 512; at time t₂, component X₂ is stored in a memory cell 513; X₃ into a memory cell 514 at time t₃, and X₅ into a memory cell 515 at time t_{N}. Next, first component X₀ and past memory H₀ are input to a function f with weight W to update cell state H₁ in recurrent relationship:
Yₜ=f(Xₜ, hₜ₋₁) where hₜ₋₁ is a past state and Yₜ is an output vector.

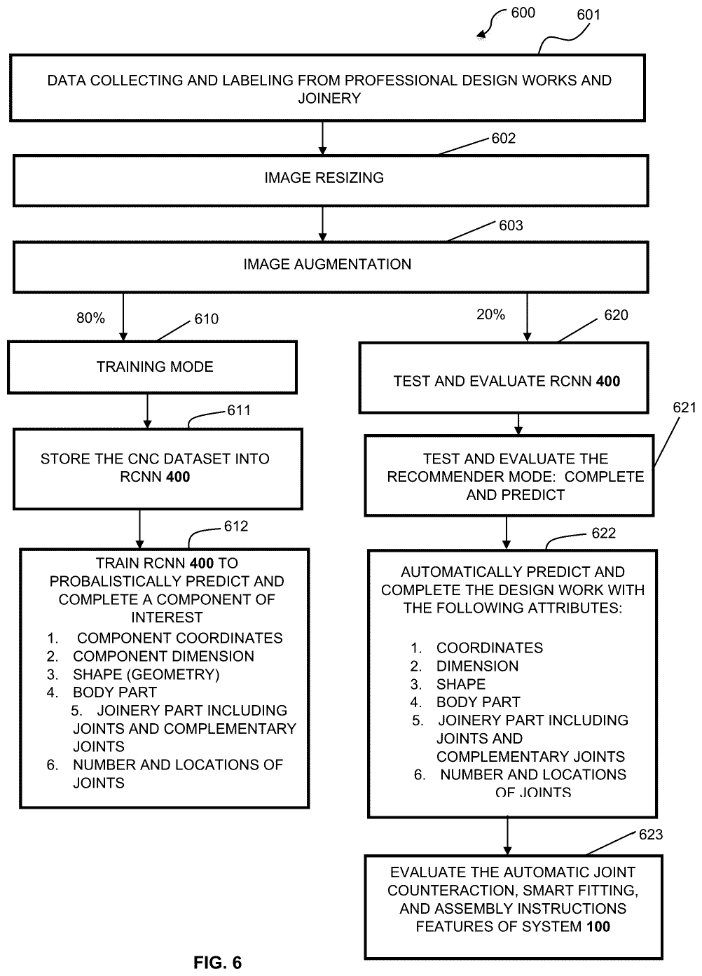

Next, referring to FIG. 6, a flow chart of a method 600 of building a machine cutting dataset and a recurrent convolutional neural network (RCNN) in accordance with an exemplary embodiment of the present invention is illustrated.

At step 601, more than six thousands individual design elements are investigated to build a machine cutting dataset. The machine cutting database of the present invention contains more than 80 types of joints among other components, sub-assemblies, and assemblies. Please refer to Table 1. Each component in the machine cutting dataset of the present invention include at least one joints, or connectors for interconnecting with other components to form a sub-assembly or assembly. Thus, the machine cutting dataset of the present invention includes approximately six thousands images representing more than 50 categories. The 50 categories include, among other things, furniture, prefabricated houses and modular walls. The machine cutting dataset collected by hand and labeled, is used to train RCNN 400 described above. Again, RCNN 400 above outputs a sequence of components with connectors and their automatic counteractions, i.e., complementary connectors. For example, if the j component is a male, RCNN 400 after trained by the machine cutting dataset in Table 1 would output a j+1 component with female connector.

TABLE 1
A List of Machine Cutting Dataset That Contains Different Types of Joineries.
Machine Cutting Dataset Contains Approximately 6,000 Elements

| | Description of | | |
|---|---|---|---|
| No. | Joinery | Sub-assembly/Components | Assemblies |
| 1. | Fingertip Tenons with | Frames, studs, sheathing, | Prefabricated houses, modular |
| | Central Positioning | joist, cap, rails, bearers, | buildings, furniture, office |
| | Tenons | trimmer, lintel, caps, nog, | buildings, furniture, residential |
| | | board, connector, baluster, | houses, house kits, bathroom, |
| | | Plate, Stringer, sheet, apron, | bedroom, basement, living room, |
| | | legs, stretchers, bathroom, | kitchen, garage, modular walls, |
| | | bedroom, basement, living | nursery. |
| | | room, kitchen, garage, | |
| | | modular walls | |
| 2. | Jigsaw Miter Joint | Same as above | Same as above |
| 3. | Double Jigsaw | Same as above | Same as above |
| 4. | Double Dovetail | Same as above | Same as above |
| 5. | Symmetrical | Same as above | Same as above |
| | Double Dovetail | | |
| 6. | Plain Sear With | Same as above | Same as above |
| | Dovetail Keys | | |
| 7. | Board Lengthening | Same as above | Same as above |
| | With Asymmetrical | | |
| | Dovetail Keys | | |
| 8. | Lengthening With | Same as above | Same as above |
| | Jigsaw Keys | | |
| 9. | Lengthening With | Same as above | Same as above |
| | Meander Keys | | |
| 10. | Detachable | Same as above | Same as above |
| | Lengthening with Key | | |
| 11. | Lapped Dovetail | Same as above | Same as above |
| 12. | Double Lapped Dovetail | Same as above | Same as above |
| 13. | Dovetail Key Corner | Same as above | Same as above |
| 14. | Miter Joint with | Same as above | Same as above |
| | Dovetail Key | | |
| 15. | Halving with | Same as above | Same as above |
| | Elliptical Tenon | | |
| 16. | Gooseneck Mortise and | Same as above | Same as above |
| | Tenon with Stub Tenons | | |
| 17. | Cross Miter Joint | Same as above | Same as above |
| | with Jigsaw Key | | |
| 18. | Shouldered | Same as above | Same as above |
| | Dovetail Halving | | |
| 19. | Stop Lap With Jigsaw Key | Same as above | Same as above |
| 20. | Hooked Jigsaw halving | Same as above | Same as above |
| 21. | Finger Tenons | Same as above | Same as above |
| 22. | Lapped Finger Tenons | Same as above | Same as above |
| 23. | Secret Finger Tenons | Same as above | Same as above |
| 24. | Fingertip Tenons | Same as above | Same as above |
| 25. | Lapped Fingertip Tenons | Same as above | Same as above |
| 26. | Secret Fingertip Tenons | Same as above | Same as above |
| 27. | Halved Dovetail Corner | Same as above | Same as above |
| 28. | Shouldered Dovetail | Same as above | Same as above |
| 29. | Oval Shouldered Halving | Same as above | Same as above |
| 30. | Double Jigsaw | Same as above | Same as above |
| 31. | Double Dovetail | Same as above | Same as above |
| 32. | Triple Dovetail | Same as above | Same as above |
| 33. | Tenon with Star Mortise | Same as above | Same as above |
| 34. | Shouldered Tenon | Same as above | Same as above |
| 35. | Locked Leg Framing | Same as above | Same as above |
| 36. | 3^{rd} Finger Tenon | Same as above | Same as above |
| 37. | Double Jigsaw | Same as above | Same as above |
| | Hook Corner | | |
| 38. | Catch Tenon | Same as above | Same as above |
| 39. | Slotting Joint | Same as above | Same as above |
| 40. | Slotting Gilder Joint | Same as above | Same as above |
| 41. | Double Lapped | Same as above | Same as above |
| | Slotting Joint | | |
| 42. | Hooked Slotting Joist | Same as above | Same as above |
| 43. | Double Lapped Slotting | Same as above | Same as above |
| | Joint With Key | | |
| 44. | Ginko Scarf With | Same as above | Same as above |
| | Stub Tenons | | |
| 45. | Hammer Tenons | Same as above | Same as above |
| 46. | Lapped Hammer Tenons | Same as above | Same as above |
| 47. | Throug hole | Same as above | Same as above |
| | Finger Tenons | | |
| 48 | Fingertip Tenon | Same as above | Same as above |
| | With Lateral | | |
| 49. | Clip Tenon | Same as above | Same as above |
| 50. | Dovetailed Cross Halving | Same as above | Same as above |
| 51. | Basic Butt | Same as above | Same as above |
| 52. | Tongue and Groove | Same as above | Same as above |
| 53. | Miter Butt | Same as above | Same as above |
| 54. | Half Lap | Same as above | Same as above |
| 55. | Mortise and Tenon | Same as above | Same as above |
| 56. | Biscuit Joint | Same as above | Same as above |
| 57. | Pocket Joint | Same as above | Same as above |
| 58. | Half Blind Dovetail | Same as above | Same as above |
| 59. | Rabbet Joint | Same as above | Same as above |
| 60. | Dado | Same as above | Same as above |
| 61. | Through Dovetail | Same as above | Same as above |
| 62. | Sliding Dovetail | Same as above | Same as above |
| 63. | Box Joint | Same as above | Same as above |
| 64. | Bridle Joint | Same as above | Same as above |
| 65. | Dowel Joint | Same as above | Same as above |
| 66. | Cross Lap Joint | Same as above | Same as above |
| 67. | Splice Joint | Same as above | Same as above |
| 68. | Finger Joint | Same as above | Same as above |
| 69. | Birds mouth Joint | Same as above | Same as above |
| 70. | Pocket Hole Joint | Same as above | Same as above |
| 71. | Rebate Joint | Same as above | Same as above |
| 72. | Cross Dowel Joint | Same as above | Same as above |
| 73. | Dado, Tongue, and Rabbet | Same as above | Same as above |
| 74. | Stopped Dado | Same as above | Same as above |
| 75. | Dovetail Dado | Same as above | Same as above |
| 76. | Dado and Rabbet | Same as above | Same as above |
| 77. | Square Splice | Same as above | Same as above |
| 78. | Half Lap | Same as above | Same as above |
| 79. | End Lap | Same as above | Same as above |
| 80. | Cross Lap | Same as above | Same as above |
| 80. | Middle Lap | Same as above | Same as above |
| 81. | Blind Miter | Same as above | Same as above |
| 92. | Special designs | Same as above | Same as above |

Next, at step 602, the images from machine cutting dataset is resized. Each image in the machine cutting dataset in Table 1 has a size 224×224×3. Images from different sources having different sizes. They are all resized to a fixed size, e.g., 229×229 convenient for RCNN 400. Different machine cutting images may have different aspect ratios and pixel sizes. Therefore, each image must be converted into an image with a specific aspect ratio and image size. In many embodiments of the present invention, the aspect ratio of an image data instance is transformed based on the greater dimension of the original image, and the nearest-neighbor method is applied to prevent image degradation in image resizing. Step 602 is implemented with the Python Keras and PIL libraries.

At step 603, the images from machine cutting dataset is augmented. Data augmentation is useful in the training process of RCNN 400. RCNN 400 operates directly on data, and the number of available training data is a crucial factor. Data augmentation of step 603 is designed to compensate for insufficient data through image transformation. Step 603 is implemented using (1) rotation (2) shifting, (3) rescaling, (4) flipping, (5) shearing, (6) zooming, and (7) stretching. The processes of augmentation of step 603 enables sample selecting, training and valuation processes in next steps. RCNN 400 use image data and/or CAD design work with specific horizontal and vertical pixel dimensions as inputs.

At step 610, after collecting, resizing, and augmenting the machine cutting dataset in Table 1, machine cutting dataset is used to train the RCNN of the present invention. More specifically, machine cutting dataset in Table 1 contain elements each represented by a pair (x,y) where x is data and y is label. The goal is to train and learn a function ƒ to map ƒ: x→y.

At step 611, the machine cutting dataset is stored into the recurrent convolutional neural network (RCNN). The original machine cutting image dataset has 500 images with 50 per classes. The test set has 20 images per class. Training and evaluation datasets with 100, 200, 400, 800, and 6,000 images are constructed separately through data processing.

At step 612, the RCNN is trained to probabilistically predict and complete a component of interest. RCNN 400 is built to recognize machine cutting objects only and disregard background such as the sky, people, or surrounding scenery. In many aspects of the present invention, components of interest can be selected by cursor 302 from different objects in the image. RCNN 400 is trained to recognize the select object of interest and attributes. The attributes include (1) coordinates of the component of interest, (2) dimension, (3) geometry or shape, (4) body part, (5) joinery part including joints and complementary joints (6) all joints on a component and their coordinates. In the present invention, the training data is 80% of the machine cutting dataset. After training, RCNN 400 extracts feature data from the input images or design works. The feature data are multi-dimensional vectors that represent the features of a design work. The training algorithm used is the MobileNet model with learning rate 0.0001, epoch is 30, loss is Stochastic Gradient Decent (SGD), the optimizer is Adam optimization algorithm. Loss function is categorical cross-entropy or maximum likelihood estimation (MLE).

Continuing with step 612, transfer learning is also used. RCNN 400 is trained for one problem is reused for similar new problems. For example, a model trained on a leg of a chair or a dovetail connector can extract the same features from other furniture or objects. This approach yields enhanced performance and saves computational power and time compared to training from scratch. The transfer learning process for machine cutting objects is as follows: (a) begin with RCNN 400 of a model pre-trained on the furniture and house dataset; (b) select layers for retraining by reinitializing the weights (W) of those layers; (c) Add new classifier on top of RCNN 400; and (d) training the new model on the machine cutting dataset.

At step 620, after training, the test and evaluation phase begin. The training dataset is 20% of the machine cutting dataset. Scores such as precision and recall are kept. The weight matrix is changed when recall score is high.

$$Precision = \frac{True Positive}{True Positive + False Positive}$$

$$Recall = \frac{True Positive}{True Positive + False Negative}$$

At step 621, the RCNN model is tested for or the prediction and completion of a design work. Each test is conducted with the same testing set. To evaluate the changes in the model learning performance according the size of the training dataset, the training is conducted by randomly selecting 100, 200, 400, 800, 1000, and 6,000 images.

At step 622, the RCNN model is evaluated for the prediction and completion of a design work. The prediction and completion of RCNN 400 provides (1) coordinates of the component of interest, (2) dimension, (3) geometry or shape, (4) body part, (5) joinery part including joints and complementary joints (6) all joints on a component and their coordinates. Especially, RCNN 400 provides automatic counteraction of a sequential component j+1 for all components j+2 that are connected to the original component j.

Next at step 623, other modules configured to perform method 100 above are also tested and evaluated. That is, smart fitting module 223 to perform step 105, and smart manufacturing module 251 to perform step 107 are also tested and evaluated. Scores in Equation above are kept and parameters of these modules 223, 251, RCNN 400 are adjusted until more than 70% success rate is achieved.

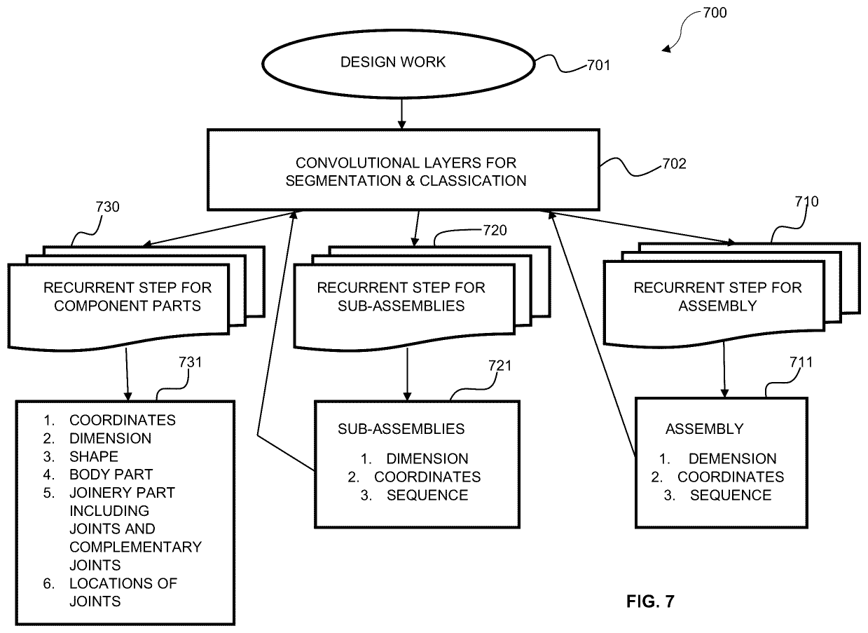

Next referring to FIG. 7, a flow chart of an analytical flow direction of RCNN 400 in accordance with an exemplary embodiment of the present invention is illustrated. Due to the attention mechanism and memory features, RCNN 400 is trained and designed to select the most basic component with joints from an assembly of interest such as chair 350. Overtime, the model puts together components {Y₀, Y₁, Y₃, . . . , Y_{N}} to predict the assembly of interest.

At step 701, a design work is input. Referring back to FIG. 5, the design work is input image 501. Input image 501 can be either CAD/CAM/CAE drawing or a photograph. Step 701 is realized by chair 350 input in graphic area 301.

Next at step 702, the design work is analyzed by CNN layer 402 having different filters to extract specific features from the design work. In many aspects of the present invention, specific features include (1) coordinates of the component of interest, (2) dimension, (3) geometry or shape, (4) body part, (5) joinery part including joints and complementary joints (6) all joints on a component and their coordinates. Step 702 also includes max pooling layers 403 and six fully connected layers 405 with 3 outputs using ReLU to reduce calculations and to avoid overfitting problems.

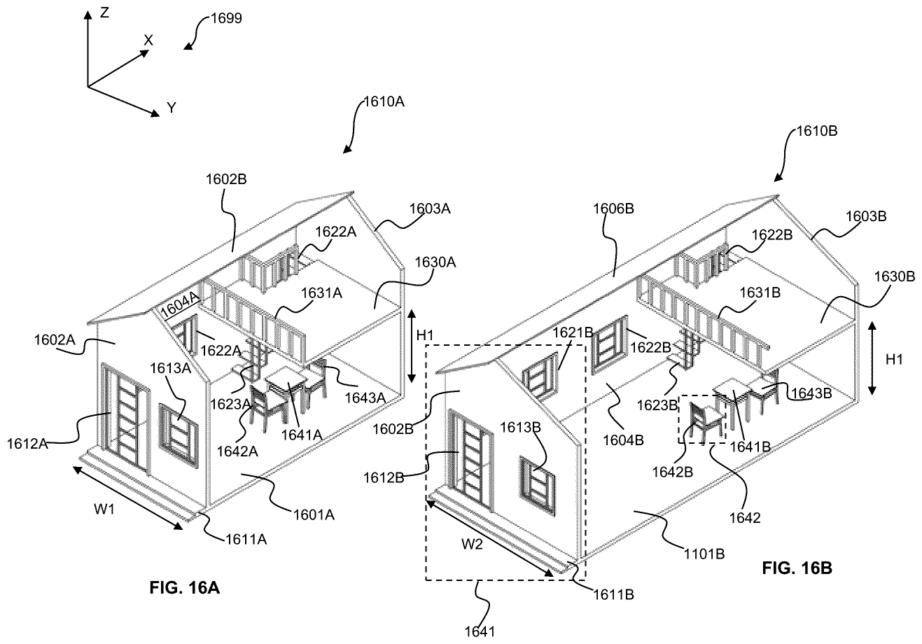

At step 710, if the output is the probability that indicates an assembly, attributes such as coordinates, sequence, and dimension are also provided. For example, the assembly in step 710 can be selected from an image of different items. The assembly can be selected using the cursor 302 such as in FIG. 16B. The probability output at step 710 indicates the assembly is chair 350.

At step 711, the assembly is further analyzed by iteratively fed back to RCNN 400. Since RCNN 400 is trained to recognize labeled or known assembly, sub-assembly, and components as shown in Table 1 above.

At step 720, if the output is the probability that indicates a sub-assembly, attributes such as coordinates, sequence, and dimension are also provided. For example, the sub-assembly in step 720 can be selected from an image of different items. The sub-assembly is a wall 1641 selected using the cursor 302 such as in FIG. 16B. The probability output at step 720 indicates the assembly is a wall 1641.

At step 721, the assembly is further analyzed by iteratively fed back to RCNN 400. Since RCNN 400 is trained to recognize labeled or known assembly, sub-assembly, and components as shown in Table 1 above. CNN layer

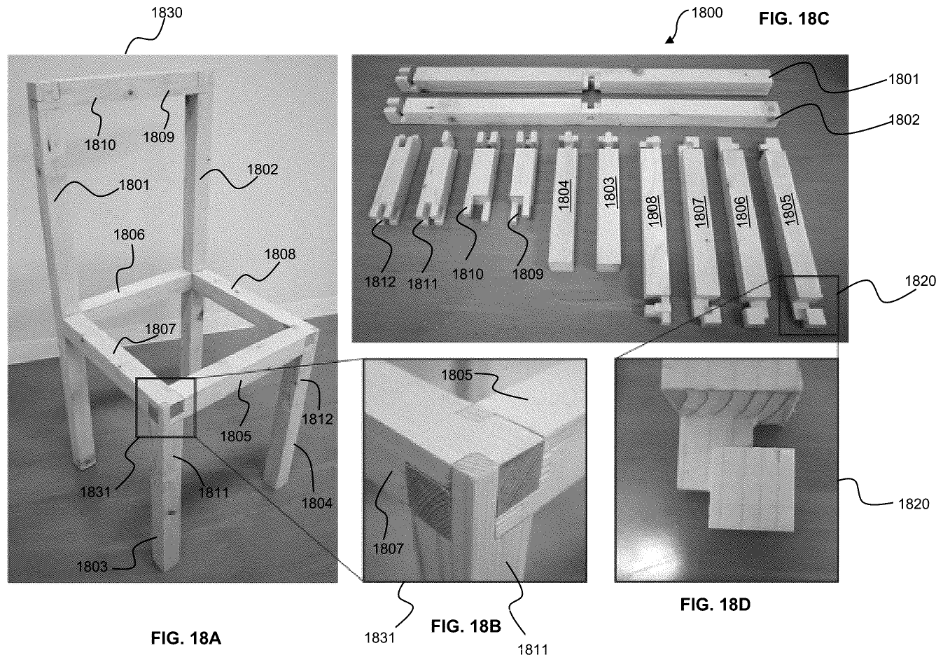

At step 730, if the output is the probability that indicates a component, attributes such as coordinates, sequence, and dimension are also provided. For example, the component in step 730 can be selected from an image of different items. The component is a leg 1803-1804 selected using the cursor 302 such as in FIG. 18A. The probability output at step 730 indicates the assembly is leg 1803.

At step 731, the component is further analyzed by iteratively fed back to RCNN 400. Since CNN layer 402 is designed to recognize labeled or known components with the following attributes (1) coordinates of the component of interest, (2) dimension, (3) geometry or shape, (4) body part, (5) joinery part including joints and complementary joints (6) all joints on a component and their coordinates.

Method 700 achieves the following objectives of the present invention:
(1) recognizing different level of a machine cutting object;
(2) recognizing the most basic component with connectors that build a final product such as a pre-fab house;
(3) providing sequential order of components that can be used in the smart fitting algorithm, action assembly instructions with bill of materials (BOM), and smart manufacturing algorithm.

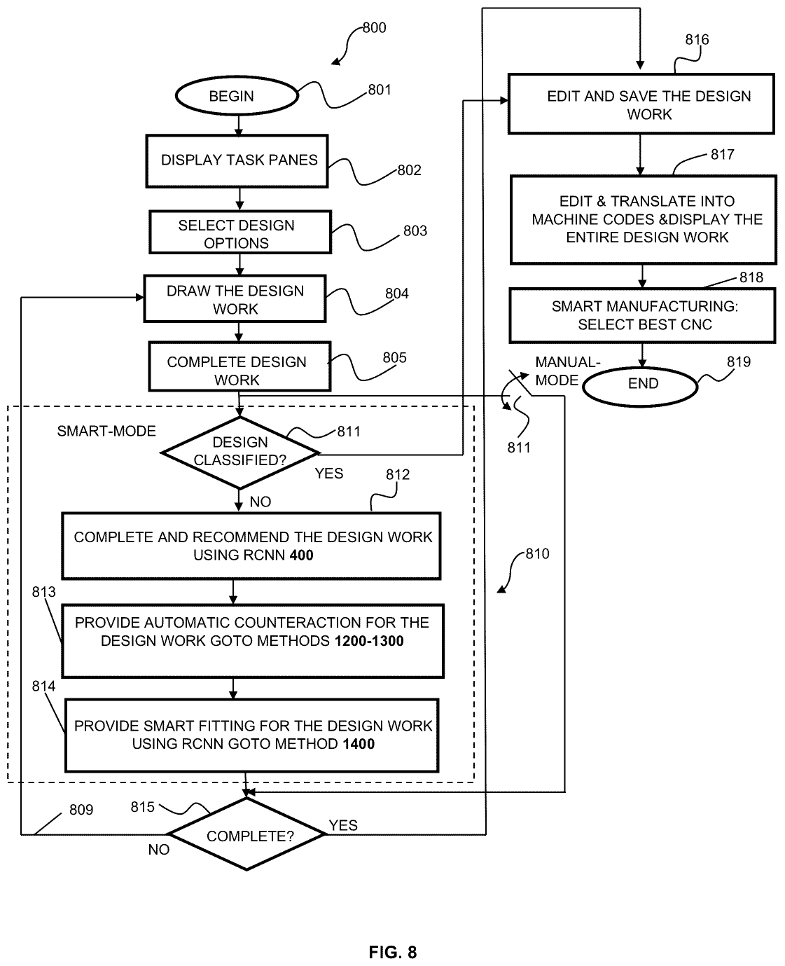

Next, referring to FIG. 8, a flow chart of a manual (manual mode) algorithm 800 for designing a design work (e.g., a chair 350 in FIG. 3) using the graphic area 300 of FIG. 3 in accordance with an exemplary embodiment of the present invention is illustrated.

At step 801, the manual mode is started. In the manual mode, a design work, e.g., chair 350 in FIG. 3, is drawn. Step 801 is realized by initializing EDI 300 and selecting setting 328 to choose manual mode. Alternatively, designers may toggle smart-mode 341 to go back to manual mode using a switch 811. In various embodiments of the present invention, switch 811 can be toggled on or off by using smart mode button 341 discussed above. In another embodiment, switch 811 between smart-mode and manual mode is toggled by opening a drop down menu such as drop-down menu 311-1 to 311-N: Start>Programs>Manual.

At step 802, a design work interface (EDI) is displayed. As alluded above, EDI 300 can be displayed by logging in into a hypertext transfer protocol (http) address. Other network layer communication protocols including user datagram protocol (UDP). Alternatively, EDI 300 can be displayed by pressing an icon on a laptop, a desktop, a tablet, or a smartphone.

At step 803, beside graphic area, task pane including all the design tools is displayed so that the designer can start designing a design work depending on whether the design task is a component, sub-assembly, or an assembly. In practice, step 803 is realized by exemplary task pane 300 discussed in FIG. 3.

At step 804, design work tools are selected from interactive EDI of step 802. In the manual mode, a designer can first open file button 311 to start a new file by choosing new file 311-4. A blank document appears in graphic area 301. Then, design button 321 is selected to start the designing process of chair 350.

At step 805, a design work such as a chair is begun and completed. In an exemplary embodiment, chair 350 is designed using design button 321 in FIG. 3. When the design chooses design 321, a dialog box, drop-down menu, or toolbar appears that allow the user to start designing using design commands including drawing, sketching, assembling, and/or inserting shapes or smart arts, etc. In a non-limiting example of step 305, the designer may use design 321 to select an insert tool (not shown) to import pre-existing designs such as seat 355 and assemble imported and designed components into chair 350. Components of design work 350 include: two front supporting legs 351, 352; two rear supporting legs 354 and 355; four spindles 356; a seat 355, four aprons 358; and three rails 357. These components can be put together using inserting function to assemble existing parts from the library together or using designing tool such as pens, cursor, etc. to draw them.

Next, within step 805, material selection is performed. After general shape of chair 350 has been designed, the material selection is realized by selecting material button 313. A dialog box displays different types of materials such as woods, metals, plastic, mica, or other materials, etc. The users may use select 325 to selectively assign materials to different components of chair 350. Alternatively, material selection step 805 can be performed in parallel as the designer complete a component of different material.

Similarly, within step 805, color selection is performed. Color button 316, when selected, displays a dialog box with a full range of color allowing the users to select the color for the entire chair e 350 or each component listed above.

Also, at step 805, joint or connection is designed or selected. In the present invention, appropriate joint or connection can be designed to best support chair 350 or other complex workpieces. Joint button 324 is selected to separately design the joint apart from the main body.

Continuing with step 805, angle or plane between parts (components) is also specified. In some designs, parts or components have different plane surfaces or angle. For example, in some joint (connection) and truss designs, such as corner joint and tee joint (90°) and edge joint (curved) need to be specified.

At step 815, as the smart-mode is disabled, the completion of the engineering is determined whether the design work is completed. This step can be realized by selecting end button 335. Alternatively, step 810 is realized using buttons save as 311-3 and giving the file a file name such as file1.doc. If the design is not completed, step 809 repeats steps 804 to 805 until the design is done.

In situations where the smart-mode is turned on by opening switch 811. Then, at step 811, based on the input by the designer, the smart-mode can recognize the component, sub-assembly, or assembly and then display the complete design on graphic area 301. Step 811 is realized by linear classifier algorithms such as Euclidean distance, Manhattan distance, Cosine similarity, Vector Support Machine (VSM) methods. The recognized design work is displayed on graphic area 301.

At step 812, if the design work is not recognized, a smart mode uses the recurrent convolutional neural network (RCNN) described in FIG. 4-FIG. 8 above is used to predict and complete the design work. Smart mode uses convolution neural network with different filter types and strides to detect the edges, and the geometry of the design work and the connectors. In case joints (connections) are not designed by the designer, smart mode 841 can calculate and select the best joint for components using the automatic counteraction. This automatic counteraction can be performed by training the RCNN so that the network can (1) recognize the connector (joinery) and (2) provide a complementary joint. For example, if the connector is a female dovetail connector, the RCNN recommends a male (opposite) dovetail connector. Please refer to FIG. 4-FIG. 8 above.

At step 813, automatic counteraction is provided. As alluded above, RCNN 400 of the present invention is trained to predict the sequential components such as j₁, j₂, . . . , j_{N} of an assembly with complementary joints or connectors.

At step 814, based on the memory and attention mechanism of the recurrent neural network, smart fitting is performed. In smart fitting, if the designer changes the dimension of the assembly, other connected components are automatically changed unless they must stay the same according to rules and regulations and/or they are not connected to the altered assembly. Step 814 saves times and increases efficiency as well as improve accuracy for the designers. In case when a design work has too many components, when the designer changes the dimension of either a component or an assembly, in the manual mode, he or she may forget to change other related components. Thus, the designer has to go back and check each component. With the smart fitting of step 814, all components connected to the changed items will be automatically changed.

Next, step 815 is determined as in the manual mode. If the design work is not completed, then step 804 and step 805 to step 814 are repeated until the design work is completed.

At step 816, after completion, the design work is edited and saved. Step 816 is realized by selecting edit button 322 and file 311 then save 311-2. Within edit button 322, other options are displayed such as eraser, tib, lines, arcs, circle, rectangle, spline, etc. Parameters including shape, geometry, dimension, order, connectors (joinery) are recorded. Step 816 is realized by the long term short term memory (LSTM) or the like (gated unit GRU) built in RCNN 400.

Next at step 817, after the design work is edited, the parameters including shape, geometry, dimension, order, connectors (joinery) are recorded. Step 816 is realized by the long term short term memory (LSTM) or the like (gated unit GRU) built in RCNN 400. In addition, in either manual mode or smart mode, after the design work is edited and satisfactorily completed by the designer, the design work is translated into machine codes by a CAD/CAM/CAE compiler. In some embodiments, the machine language is a G-codes (RS-274), M-codes, and their variants.

At step 818, a smart manufacturing process of the design starts. Smart manufacturing step 818 connects different types of CNC machines tools and 3D printers via a network, finding the best one to manufacture a component, and observing the manufacturing process in real-time of each component by a particular CNC machine or 3D printers. Machine cutting (MC) tools and 3D printers are assigned that best manufacture a components/parts of a design work. This step can be achieved by assessing the capability of each CNC machine tool and 3D printers. Few exemplary features which are used to implement step 818 include dimension, geometrical shapes, and complexities of each component.

For example, the flat geometrical shape of seat 255 cannot be machined by many Machine cutting (MC) tools. In another example, joint and connectors are complicated and cannot be machined by many Machine cutting (MC) tools. As such, these components are assigned to special Machine cutting (MC) tools or 3D printers. On the other hands, front legs 351-354, aprons 358, and rails 357 can be machined by Machine cutting (MC) tools. However, they are best manufactured by an omni-directional Machine cutting (MC) tools that are disclosed by the parent application entitled, “Omni-directional Computerized Numerical Control (CNC) Machine Tool and Method of Performing the Same”.

At step 819, the manual mode ends. Step 819 is realized by select file button 311, open 311-1 or new 311-4. Alternatively, end button 335 is selected to end either manual mode or smart mode. A close button (now shown) in file menu button 311 can also be used.

Process 800 of the present invention achieves the following objects:
(1) assisting users in the manual mode using the smart mode facilitated by the recurrent convolutional neural network (RCNN), increasing efficiency and convenience;
(2) achieving efficiency and high through-put in the manufacturing phase.

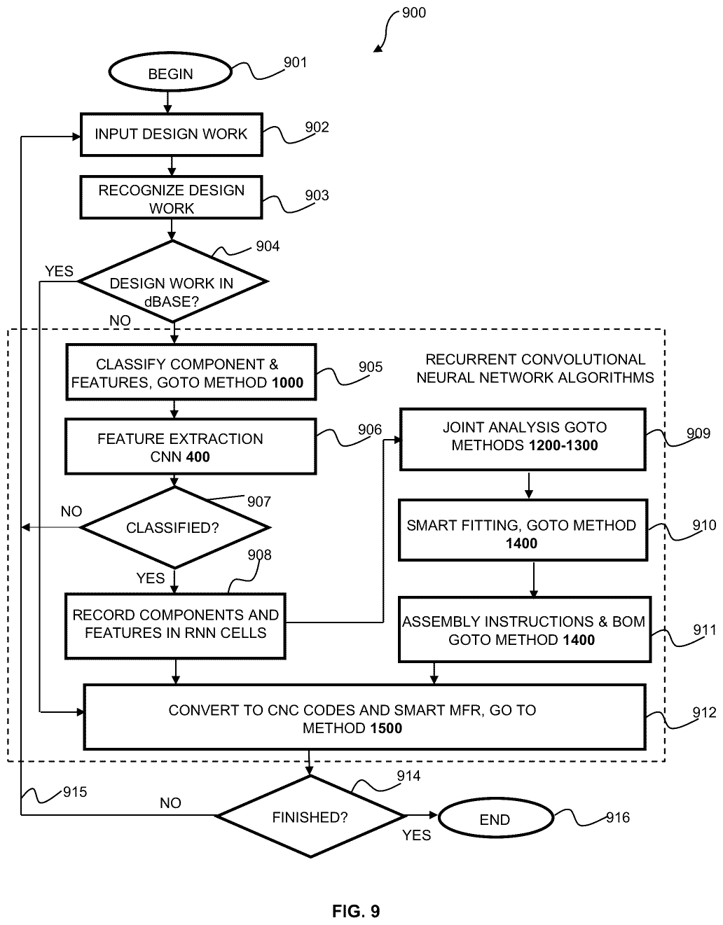

Next referring to FIG. 9, a flow chart of recurrent convolutional neural network (RCNN) based smart mode 900 in accordance with an exemplary embodiment of the present invention is illustrated. In some exemplary embodiments, deep learning algorithms 400 uses a convolutional neural network (CNN) and/or a recurrent neural network (RNN) configured to recommend and complete an design work.

At step 901, the smart mode begins. This step is realized by a designer's pressing smart-mode button 341; or, equivalently, switch 811 Consequently, the smart mode takes over and the designers only need to input the design specification or description in form of images, text description, voice description, and/or an incomplete CAD/CAM/CAE design.

At step 902, a design work is input. In advantageous embodiments, step 902 is implemented by the following non-limiting methods are used to input design specification: (1) by written description; (2) voice activation; (3) incomplete or partial design work; and (4) photo images. These different input specification formats are translated and/or then digitized into vector files containing of bits and pixels. Furthermore, these inputs are either stored in databases, imported from the Internet, and/or designer's direct input to graphic area 301, from chat forum 243 and/or auxiliary display panel 360. In one particular situation, the designer may retrieve a partially complete or incomplete design specification from file menu 311 by executing file 311, open 311-1, and then selecting the file.

Next, at step 903, the design specification from step 902 is detected. In many aspects of the present invention, step 903 affords the designers to provide different content information including text, image, audio, and even video inputs. If the design specification is in written text, text recognition engine is used to understand the input text. In some embodiments, an optical character recognition (OCR) engine or a deep text recognition benchmark is used. If the design specification is input using an audio input, a voice recognition tool such as Window 10, Siri, or the likes is used. Within the scope of step 903, a Euclidian distance algorithm is used to classify and search for the input design specification. After understanding the input design specification, algorithm 900 converts the design work input into a vector.

In many advantageous embodiments of the present invention, parametric linear classifier is used. In some other embodiments, the Euclidian distance algorithm is performed to find a match (or dissimilarity). Alternatively, in other embodiments, a K-nearest neighbor algorithm, Manhattan distance algorithm, cosine similarity algorithm, or vector support machine (VSM) is used. It is noted that, within the scope of step 903, every learned or known workpiece stored in the database is participated in the aforementioned algorithms. Additionally, the database includes internal database or cluster databases connected together via a network such as cloud network, LAN, WAN, etc.

At step 904, if the input design specification is decoded and the design work exists in a database then algorithm 900 goes to step 915 which displays the retrieved design work in graphic area 901 for review and/or edit. As a non-limiting example, if the engineering specification describes a chair such as chair 350. If the description or design work of chair 950 is decoded and understood, chair 950 is retrieved and displayed on graphic are 901. From this, the designer may disassemble chair 350 into components to edit or to review.

At step 905, if the design work is not previously stored in a database, it is inferred using RCNN 400. RNN layer 402 partitions design work into components using feature detection of convolutional neural network (CNN) that include different filter types. Then, recurrent neural network (RNN) layer 700 uses its memory and attention mechanism to put together the components in sequential order into the design work. For example, if chair 350 is not previously stored in a database, step 905 receives either chair 350 or leg 351. Step 905 uses RCNN 700 to predict leg 351 if the input design work is a leg. If the design work is chair 350, step 905 outputs chair 350 when the first input design work is leg 351. Please refer to method 1000 for more detailed disclosure of different input design works.

At step 906, each component is classified using RCNN algorithms. CNN layer 402 scans the entire the input design work using different filters 402-1 to 402-6 and strides to detect the shapes, the edge, and special features of the joints of each constituent component of the design work.

At step 907, whether a component is successfully classified is determined. Step 907 is realized by fully connected (FC) layer 405 that output probabilities. During the training period, the loss function is set to obtain RMS error between the difference between the input design specification and the teaching components in the dataset is less than 10%.

At step 908, if the component is successfully classified, they are stored in memory cells 531, 532, 533, and 534 respectively to build step-by-step assembly instructions for either end-users or assembling robots. In many aspects of step 908, the step-by-step assembling instructions can be in form of assembly drawings for end-users. Assembling drawings of the present invention include 3D modeling, views or orientation, components, connectors, geometrical shape and sizes of each component. They all have Cartesian coordinates. Step 908 uses these information to generate a blocking list or an occlusion lists. The blocking lists show which connectors or which parts are blocked by other components if they are not connected first. Each group of components has a blocking list. Then, based on the blocking list, group ID, component ID, connector ID, geometrical shapes and sizes, and their coordinates and the above ID codes, step 908 generates either a video animation or a step-by-step assembly instructions.

Next, at step 909, joint and blocking analyses are performed. Even though RCNN 400 is trained to recognize complementary of joints and type of parts (significant and non-significant), blocking analysis and joint sequencing need to be analyzed for the action assembly instructions. Briefly, hierarchy and grouping parts are analyzed. Components are divided into significant parts which are the design work and insignificant parts which are screws, fasteners, dowels, etc. There are three set of orthogonal planes: sagittal plane, coronal plane, and transverse plane. Components on the same plane or parallel plane are usually assembled first. Then, Next components in a sequence if circumscribed or contained inside another component without sufficient exit or entry openings should be connected first. The details of joint analysis, please refer to methods 1200-1300.

At step 910, smart fitting is analyzed. As mentioned above, in the smarting fitting algorithm, components or sub-assembly connected to other assemblies, sub-assemblies, or components whose dimensions have been changed. Briefly, components are analyzed to determine if they are in a sequence (j₁, j₂, . . . , j_{N}) with the changed components. If they are not in the same sequence, and if the components must obey construction regulations such as door frames, ceiling height, etc., then these components are not changed. Please refer to method 1400 for more details.

At step 911, the assembly instructions and bill of materials are generated. Step 911 is realized by RCNN 400. In order to generate the assembly instructions, blocking analyses are performed as described above and in method 1400.

At step 912, the final design work is converted to machine codes and attributes are generated. The attributes of the design work are compared with those of CNC including CNC-1, CNC-2 . . . , CNC-N, laser cutters, or 3D printers. The best CNC or other types of machine cutting devices will be assigned to manufacture a specific design work.

At step 914, whether a design work is final is determined. If yes, then process 900 ends at step 916. Otherwise, if not, step 902 to step 914 is repeated via a path 915.

Now referring to FIG. 1000, an algorithm 1000 describing different methods of importing and completing a design work in accordance with an embodiment of the present invention is illustrated.

At step 1001, algorithm 1000 begins. Step 1001 is implemented by opening EDI 300 as described in FIG. 3.

At step 1002, whether designer design or smart-mode or a manual mode is used. In many different aspects of the present invention, step 502 is implemented by EDI 200 in which a designer may initiate auto-mode button 241 or continuing the manual mode as described in algorithm 300 of FIG. 3.

At step 1003, the manual mode is activated. If the manual mode 800 as described in FIG. 8 is preferred, the designer can complete an entire design work from idea to end. Step 1003 is realized by CAD/CAM/CAE engine similar to SolidWorks, CATIA, etc.

At step 1004, whether the design work is inputted from a database is determined. When manual-mode is not actively turned on, step 1004 is realized by pressing import button 347 or from import 311-5 of a drop-down menu of file button 311. Alternatively, the designer may activate users 334 button to import a design work from the databases of other users or from the cloud. Step 1004 is used when the designer has previously worked on design works stored in a database.

At step 1005, whether the input design work is imported from the worldwide web or from social media is determined. In many aspects, the designer may activate worldwide web (www) button 333 to select a preferred design and then drag that design into the graphic area 301. Alternatively, input design work may be imported from browsing a website of a seller or a retailer. Yet, in other aspects, input images may be imported from social media such as Facebook, Tiktok, web-based reference sharing platforms where everyone collect and share design references image with well-organized information. For example, “Houzz.com” is a commonly visited reference platform.

At step 1006, whether the smart-mode is activated is determined. In many advantageous aspects of the smart-mode, the designers use the smart-mode to complete a design work without repeating components which are the same or similar to previously input components. As described in FIG. 9, the smart-mode includes the smart dimension, smart number, and automatic counteraction. That is, in the smart-number, if supporting leg 351 of chair 350 is designed, then the remaining supporting legs 352-354 are automatically created with exact dimension and geometry. Additionally, in the smart-dimension, when the surface area of seat 355 is changed, the dimensions of aprons 358 and cross stretchers 356 are automatically changed. In automatic counteraction, the joints of front legs 351-354 are automatically provided to connect to those of cross stretchers 356 and aprons 358 so that these components are connected to one another.

At step 1007, if a portion of a design work is selected by a cursor, then the selected portion is analyzed in the smart mode. Step 1007 is realized by cursor 302 that selects chair 1642B or a wall 1641 in FIG. 16B. If the designer does not use cursor 302 to select, then the entire design work is analyzed down to the component level as described in details in method 1300.

At step 1008, the segmentation and classification algorithms are used to identify the input design work from different sources. In various embodiments of the present invention, if the input design work is in form of CAD/CAM/CAE format from manual mode of step 1002, step 1005 is omitted. On the other hand, if the input design work is in form of photo images imported from a database of step 1003 or from a social media of step 505, classification and segmentation algorithms such as convolutional neural network (CNN) is used to separate the target input design work, e.g., chair 350 from other items in a photo. For example, please refer to FIG. 4, filters 402-1 to 402-6 in CNN layer 402 can segment a chair 1642B from a different items in a house 1610B.

At step 1009, after the segmentation and classification algorithms are successful, each component of the target design work is analyzed by the RNN algorithms. Step 1009 is performed by the RCNN 400 and method 1300 that can recognize each component of a target design work. In the chair example, once chair 350 is segmented and classified, its components such as supporting legs 351-354, cross stretchers 356, aprons 358, seat 355 are further segmented and analyzed. This component analysis includes: geometry, dimensions, joinery, locations of joinery, etc. It is made possible by RCNN 400.

At step 1010, after the component analysis is performed, the complete design work is displayed in the graphic area and analyzed using smart-mode including smart fitting, automatic counteraction, and action as described in method 900. Step 1009 is realized by graphic area 301 for review for possible edits by the designer. In addition, smart fitting, automatic counteraction, and smart manufacturing are described above in method 900.

Continuing with step 1010, an assembly instruction and bill of materials of the design work are generated. Step 1010 is realized by the inherent structure of recurrent neural network (RNN) that has long term short term memory (LTSM) that keeps track in time order of each component of the design work.

Finally, at step 1011, process 1000 ends. Step 1011 is realized by the designer pressing a close button under file menu 211. Alternatively, the designer may end process 500 by doing nothing for more than a preset time period.

As seen above, process 1000 of the present invention achieves the following objects:
(1) assisting designers to complete an incomplete design using recurrent convolutional neural network (RCNN) based recommender system;
(2) providing designers with product ideas from various online sources such as Facebook, Google, etc. using RCNN algorithms of the present invention; and
(3) providing step-by-step assembling instructions to end-users and assembling robots.

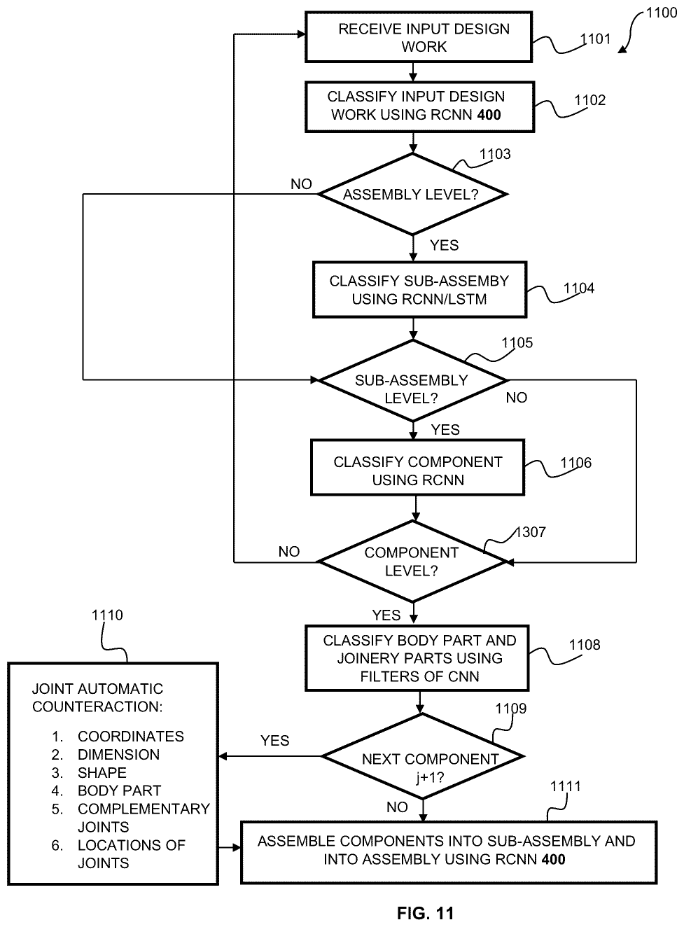

Now referring to FIG. 11, a flow chart describing component level analysis methodology 1100 in accordance with an embodiment of the present invention is illustrated. As alluded above in step 512 of FIG. 5, auto-mode algorithm 600 provides pre-existing components, geometrical shapes, as well as dimensions to at least one components received in the design area. This aspect of the present invention aims to reduce unnecessary designing time to designers, thus increasing accuracy and efficiency.

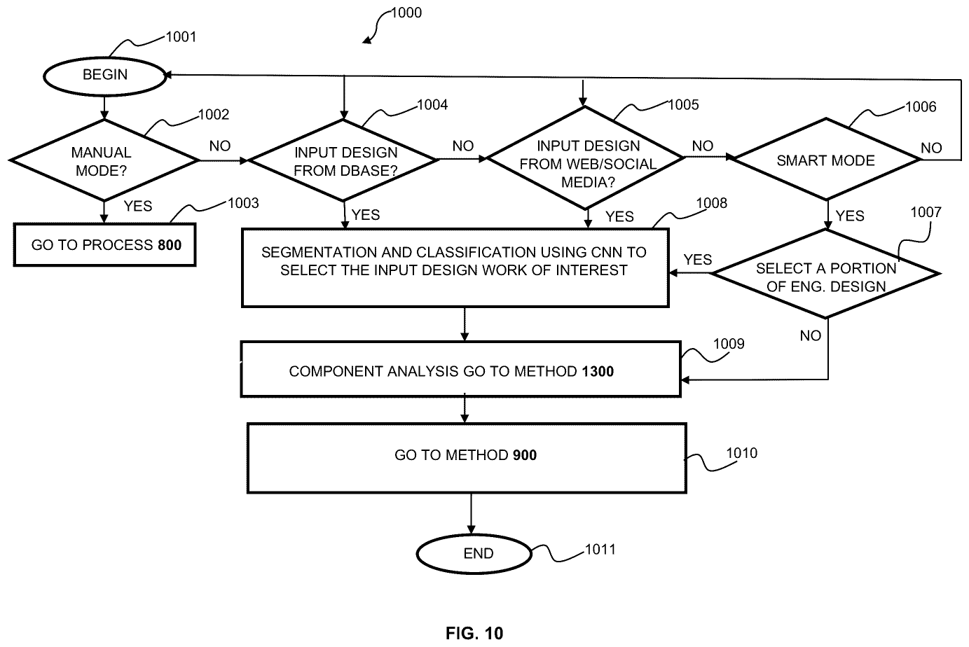

At step 1101, a design work is received. Again, step 1101 is realized by a designer is drawing a design work on graphic area 301. Alternatively, the design work is also imported from various input sources specified in FIG. 10 including from databases 1004 and websites and/or social media 1005.

At step 1102, the design work is analyzed by RCNN 400 in the smart mode. In a non-limiting example, step 1102 is realized by smart mode 900 described in FIG. 9 which is based on RCNN 400.

At step 1103, whether an assembly is input from step 1102 is determined. In the present invention, step 1103 is realized by RCNN 400 described above. For example, if chair 350 is received, step 1103 outputs an assembly of chair 350 for further analysis. The manner RCNN 400 segments and analyzes a design work is disclosed above in FIG. 4 to FIG. 7. Alternatively, in case the assembly has been created before, step 1103 uses the associative principle capable of recognizing the entire design work just from a constituent component. Please refer to step 902 and 903 disclosed above.

At step 1104, if the design work is an assembly, then next parts (components) are designed and inputted into the design area. More particularly, if chair 350 is recognized, then RCNN 400 analyzes at sub-assembly level which are legs 351-354, aprons 358, seats 355, etc. Again step 1004 is realized by filter 402-1 designed to search for the shape of the design work as disclosed in RCNN 400.

At step 1105, if the answer to step 1103 is not an assembly, then whether a sub-assembly is input from step 1102 is determined. In the present invention, step 1105 is realized by RCNN 400 described above. For example, if wall 1641 in FIG. 16B is received, step 1105 outputs a sub-assembly of chair wall 1641 in FIG. 16B for further analysis. The manner RCNN 400 segments and analyzes a design work is disclosed above in FIG. 4 to FIG. 7. Alternatively, in case the sub-assembly has been created before, step 1105 uses the associative principle capable of recognizing the entire design work just from a constituent component. Please refer to step 902 and 903 disclosed above.

At step 1106, if the design work is a sub-assembly, then next parts (components) are designed and inputted into the design area. More particularly, if wall 1146 is recognized, then RCNN 400 analyzes at component level which are front door 1612B, window 1613B, and front step 1611B. The internal structure of wall 1602B is also analyzed. Again step 1004 is realized by filter 402-1 designed to search for the shape of the design work as disclosed in RCNN 400. In case wall 1602B is a pre-fabricated single piece wall, then RCNN 400 of step 1106 further analyzes components in window 1613B and front door 1612B.

At step 1107, whether the sub-assembly is input from step 1102 is determined. In the present invention, step 1107 is realized by RCNN 400 described above. For example, if a leg 351 is received, step 1107 outputs leg 351 for further analysis. The manner RCNN 400 segments and analyzes a design work is disclosed above in FIG. 4 to FIG. 7. Alternatively, in case the component has been created before, step 1107 uses the associative principle capable of recognizing the entire design work just from a constituent component. Please refer to step 902 and 903 disclosed above.

At step 1108, if the design work is a component, then next parts (components) are designed and inputted into the design area. More particularly, if leg 351 is recognized, then RCNN 400 analyzes for further details. Again step 1008 is realized by filters 402-1 to 402-6 designed to search for the shape, connectors, and coordinates of the design work as disclosed in RCNN 400.

At step 1109, whether there are other sequential components j₁, j₂, . . . , j_{N} associated with the input component j₀ is determined. In realization of step 1109, RCNN 400 and layer 700 as disclosed in FIG. 4 is implemented.

At step 1110, if there are sequential parts associated with the input component, then RCNN 400 is trained to provide complementary joints for the predicted components j₁, j₂, . . . , j_{N}. The training and operations of components are disclosed above in FIG. 4-FIG. 7.

At step 1111, after either automatic counteraction and there are no more components to analyze, all components j₀, j₁ j₂, . . . , j_{N} are assembled into sub-assembly or assembly. For example, legs 351-354, stretchers 356, aprons 358, seats 355 are assembled into chair 350. Please refer to FIG. 3.

As seen above, Auto-mode algorithm 1100 of the present invention achieves the following objects:
(1) reduce the design into components for further analyses such as smart fitting, smart manufacturing, and action assembly instructions;

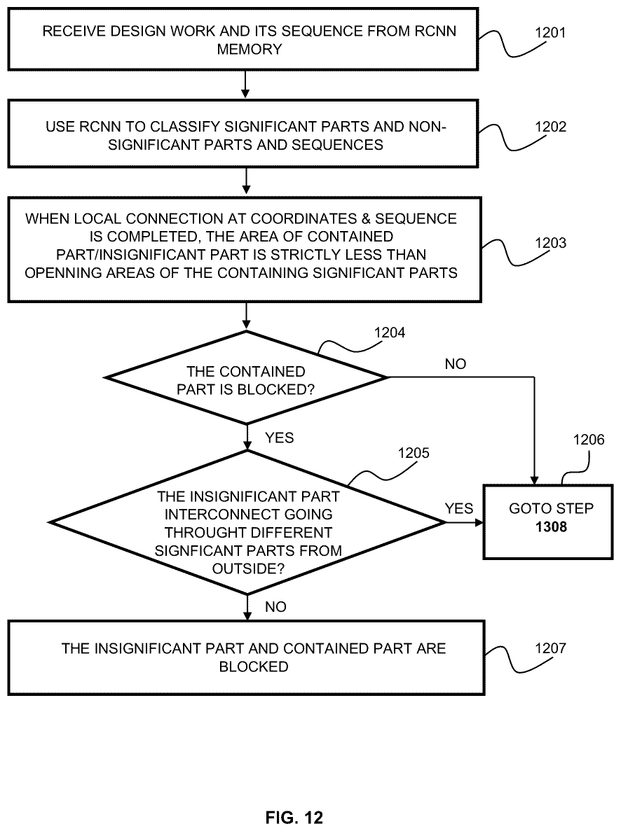

Next referring to FIG. 12, a flow chart of an automatic counteraction algorithm 1200 in accordance with an exemplary embodiment of the present invention is illustrated. Algorithm 1200 is based on operations and memory features of RCNN 400.

At step 1201, a design work including component sequence is received. In the present invention, design work such as chair 350 is received at graphic area 301.

At step 1202, the design work is analyzed for significant parts and non-significant parts. The significant parts are components j₀, j₁, j₂, . . . , j_{N} that make up a sub-assembly such as wall 1641 or an assembly such as chair 350 or house 1610B. Non-significant parts are fasteners, dowels, screws, nails, brackets, etc. those miscellaneous parts that help secure components together. Step 1202 is realized by training CNN filters 402-1, 402-2, . . . 402-6 in FIG. 4 to recognize significant parts and non-significant parts.

At step 1203, when a specific connection at a specific coordinate specified in the recurrent neural network is performed, blocking analysis is performed. The blocking analysis is based on the sequence j₀, j₁, j₂, . . . , j_{N} of the RCNN 400. That is, whether the smaller component is contained within the other larger component without exit/entry is examined. Since the shape and coordinate of each component is known by the operation of RCNN 400, blocking analysis of step 1203 is achieved. Furthermore, graphic analysis of CAD/CAM/CAE of the present invention is also used to determine whether a component is blocked inside another component.

At step 1204, whether a contained component is blocked by other components is determined. Step 1204 is accomplished by calculating whether the contained component has sufficiently large entry/exit area when connected with the containing component. RCNN 400 and the CAE module with constraint based design approach (CBDA) and freedom and constraint topology (FACT) is used to implement step 1204.

Next at step 1205, whether insignificant parts interconnect significant components together go through other significant components from outside is determined. Step 1205 is implemented using RCNN 400 and spatial and geometric data from the CAD module. That is, RCNN 400 provides the sequence order of significant and insignificant components with attributes listed above in FIG. 4. With the coordinates and shape (geometric data) at each connection, the CAD module can determine whether an insignificant part such as a dowel interconnect significant components from outside or inside. It is well-known that dowels are usually interconnect significant components such as bookshelves from inside.

At step 1206, if the answer to step 1205 is YES, then go to step 1308 for action assembly instructions.

At step 1207, if the answer to step 1206 is NO, then it is concluded that the insignificant part is blocked and it is needed to connect first.

At step 1301, the process for assembly instructions begin. Step 1301 is realized by pressing button assembly 325 in EDI 300.

At step 1302, the blocking analysis as disclosed in method 1200 and FIG. 12 above is performed.

At step 1303, based on method 1200, whether the significant components, when connected to other significant components, are blocked is determined.

At step 1304, rule number one is performed. If any of the components at specific connection coordinate are blocked (by the connections of other components), then those components should be connected before the blocking components. For example, if seat 358 and front legs 351-352 are connected to hind legs 353-354 first, aprons 358 will be blocked. Thus, according to rule number one, aprons 358 should be connected to hind legs 353-354 first. And then front legs 351-352 are connected to aprons 383. Next, seat 355 is connected to hind legs 353-354.

At step 1305, rule number two is recommended. In assembly, three planes of references: coronal plane, sagittal plane, and transverse plane are used as reference. Significant components on the same plane or its parallel are connected first. This is to avoid components from being blocked by other components in different planes. For example, hind legs 353-354, rails 357, and stretcher 356 on the coronal plane should be connected first. Otherwise, if apron 358 on the transverse plane is connected to hind leg 353-354 first, fixing the distance there between, rails 357 cannot be connected to hind legs 353-354.

At step 1306, rule number three is performed. In rule number 2, significant components j₀, j₁ j₂, . . . , j_{N} on the same plane are open-looped connected first. Within the scope of the present invention open-looped connection means connecting all the components on one side first without closing up these components. Next, closing up the components on the same plane by connecting them to those on the other side. As an illustrating example, rails 357, stretcher 356, and apron 358 are connected one by one to hind leg 353 first without connecting to hind leg 354. This process is called open-looped connection.

At step 1307, rule number four is performed. In rule number 3, after components in one plane are connected, assembled components on orthogonal planes such as transverse plane and sagittal plane are connected together and to those on the coronal plane. In chair 350, aprons 358 and seat 355 that are on the transverse plane is connected to hind legs 353-354, rails 357 as described above in step 1305.

Next at step 1309, use the sequence of RCNN and rules 1-4 above to generate action assembly instructions. Step 1307 is realized by RCNN 400.

At step 1309, if the components are not blocked, then perform rule 1-4 in any order.

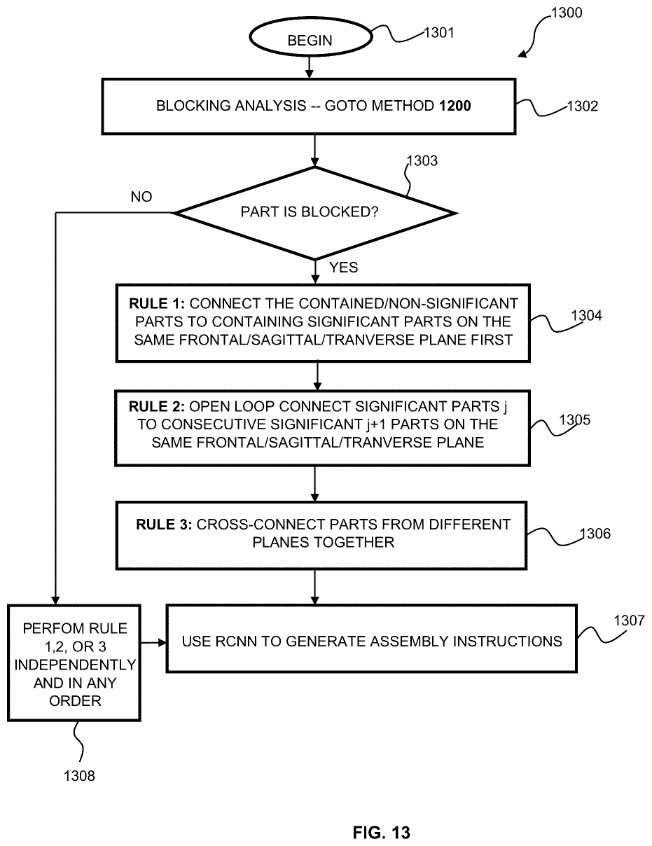

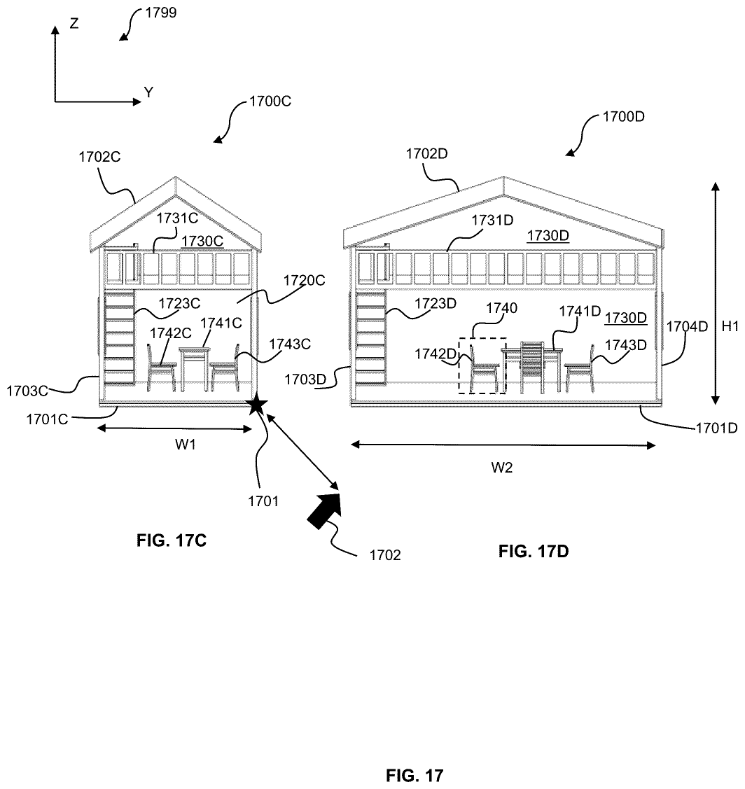

Next referring to FIG. 13, a flowchart of a smart fitting algorithm 1400 in accordance with an exemplary embodiment of the present invention is illustrated. Smart fitting algorithm 1400 automatically adjusts the dimensions of all connected components to components, sub-assemblies, or assemblies that have been changed dimensionally. Smart fitting algorithm 1400 depends on RCNN 400. Please refer to FIGS. 16A-16B and FIGS. 17A-17B for illustrations.

At step 1401, algorithm 1400 begins. Step 1401 is realized by pressing button assembly 325 in EDI 300.

At step 1402, a component, a section of a design work, or an entire design work is input. Step 1402 is realized by draw button 334 in FIG. 3. When a designer moves cursor 302 to draw button 334, a menu (now shown) will appear that allows the designer to select different draw functions such as lines, curves, arcs, sketches, threads, fillets, chamfer, bevel, spline, rib, shell, and wraps. Alternatively, the designer may retrieve a previous design work from the database. Alternatively, step 1402 is realized by using cursor 302 to select a portion of a design. Please refer to FIG. 16A and FIG. 16B. In FIG. 16B, cursor 302 is used to select wall 1641. In another example, cursor 302 is used to select a chair 1642—a part inside a house 1610B but not constituent components that make up house 1610B.

Next, at step 1403, based on the current input, determining if the dimension of the design work is changed. Step 1403 is realized by using cursor 302 to grasp a vertex 1701 of a house 1700A and drag it out to enlarge a house 1700A, which results in a house 1700B. In another aspect of the present invention, step 1403 is realized by manually entering the new dimension for house 1700A.

At step 1404, the dimension of the design work is updated. In the smart mode, all the components or parts of the design work are automatically updated without the designer having to manually changing each component or part. Step 1404 is realized based on the sequence outputs of RCNN 400. More particularly, step 1404 uses outputs Y₀ 531, Y₁ 532, Y₂ 533, and Y₃ 534 to change the dimensions of the components or parts.

At step 1405, whether components or parts are connected in sequence is determined. Again, step 1405 is realized by using the outputs of RCNN 400 which has arranged components and parts in sequential order.

At step 1406, if components are connected together in order whether components or parts are repeated or duplicate is determined. Step 1406 is realized by relying on the outputs of RCNN 400. For example, front legs 351-352, hind legs 353-354, stretchers 356, rails 357, and aprons 358, each having duplicate components. They are similar and must be changed together.

At step 1407, the number of duplicate parts or components is retained. Step 1407 of method 1400 keeps track of the number of duplicate parts or components. For example, for hind legs 351-352 is two; for front legs 353-354 is two; for rails 357 is four; for aprons 358 is four; and for stretchers 356 is also 4.

At step 1408, the dimension of components and parts in sequence are changed in accordance with the same aspect ratio and proportionality measured in step 1403.

At step 1409, if some components kth are not in sequence with the remaining components j₀, j₁, j₂, . . . , j_{N} then the kth components are determined if they must obey dimensions specified by rules or regulations. Step 1409 is realized by metadata and attributes of each component specified by the CAD/CAM/CAE software. For example, the height H₁ and front windows 1613A and door 1612A of a house 1610A may have to obey local ordinances.

At step 1410, if the kth components are not within the dimension rules and regulations, then whether these kth components are changed by the designer are determined. Step 1410 depends on the designer's. For example, chairs 1642A-1643 and dining table 1641A are neither part of house 1610A nor in the requirements of any regulations and rules. It depends on the designer's aesthetics to change the dimensions of these items. In case the designer decides to change, then repeat step 1406 to step 1408.

At step 1411, after all components are changed, they are coupled together in sequential order j₀, j₁ j₂, . . . , j_{N}.

At step 1412, the new dimensions of the design work are saved and assigned to different codes.

At step 1413, the new design work with new dimensions is displayed in the graphic area.

At step 1414, the smart fitting method 1400 ends. This step is realized by saving button 311-2 or save as 311-3.

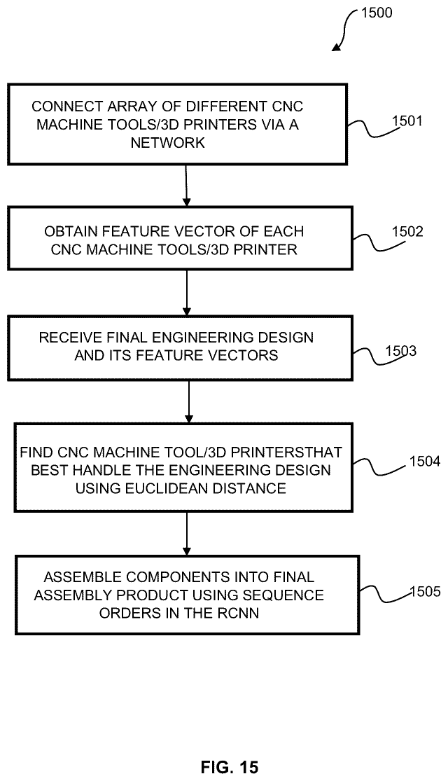

Next referring to FIG. 15, a flow chart of a smart manufacturing algorithm 1500 in accordance with an exemplary embodiment of the present invention is illustrated. Smart manufacturing algorithm 1500 assigns a component j₀, j₁ j₂, . . . , j_{N} of a design work to the best machine cutting tool that can cut that specific component in the shortest time and the minimal error.

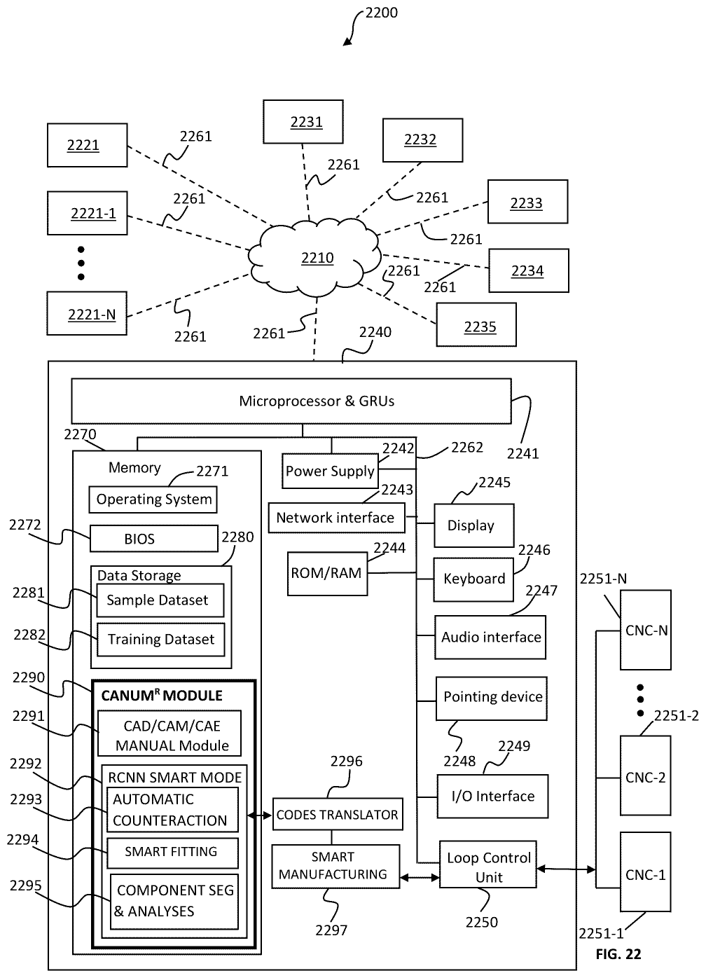

At step 1501, an array of different machine cutting (MC) tools are connected to a network and a driver device that is operated by method 100 above. Step 1501 is realized by system 200 disclosed in FIG. 2 and system 2200 in FIG. 22. Machine cutting tools include CNC machines such as CNC 2100, laser cutters, and 3D printers.

At step 1502, feature vector of each machine cutting tools are created. assembly instruction rules 1300 in accordance with an exemplary aspect of the present invention is illustrated. Feature vector includes
(a) Name—the feature vector's name as will be later addressed in the store reference store://feature_vectors/<project>/<feature-vector-name> and the UI (after saving the vector); (b) Description—a string description of the feature vector. (c) Features—a list of features that comprise the feature vector. The feature list is defined by specifying the <feature-set>.<feature-name> for specific features or <feature-set>*for all the feature set's features. Feature includes type, address, properties, speed, efficiency, etc. listed in features 332-2 in FIG. 3; and (d) Label feature—the feature that is the label for this specific feature vector, as a <feature-set><feature-name>string specification.

At step 1503, feature vector of each final design work is obtained. Similar to the feature vector of the machine cutting tools, the feature set of the design work includes type, shape, dimension, joinery, etc.

At step 1504, the best machine cutting tool for a specific component is found using Euclidean Distance or similar methods or Cosine similarity, or cosine dissimilarities. For example if a feature vector of a specific machine cutting tool such as CNC 1300 in FIG. 13 is specified as: \vec{a}={a₁, a₂, a₃, . . . , aₙ}; and the feature vector of a design work is \vec{b}={b₁, b₂, b₃, . . . , bₙ)}. Step 1504 is realized by the dot product between two feature vectors: \vec{a}·\vec{b}. Alternatively, cosine similarity is used

$$cos ( \vec{a} , \vec{b} ) = \frac{\vec{a} \cdot \vec{b}}{‖ \vec{a} ‖ ‖ \vec{b} ‖}$$

At step 1505, after each component is cut by different machine cutting tools, they are collected and assembled according to method 1300.

In FIG. 16A-16B, a 3D perspective diagram of a house illustrating component analysis and smart fitting features of the Recurrent Neural Network (RNN) of the present invention is illustrated. FIG. 16A shows a house 1610A and furniture in their original sizes. In FIG. 16B, shows a house 1610B, after the size has been changed. RCNN 400 recognizes that some parts of house 1610B will be changed and some will not be changed.

More particularly, in FIG. 16A, house 1610A is designed using design work interface 300 described in FIG. 3. House 1610A includes a floor 1601A, a roof 1602B, a front wall 1602A, a side wall 1604A, a front door 1612A, a front window 1613A, a front step 1611A, and a back wall 1603A. House 1610A has a width W1 and length L1. Inside, house 1610A has a window 1622A, a staircase 1623A, a table 1641A, a pair of dining chairs 1642A-1643A (similar to chair 250 described above). Staircase 1623A leads to a mezzanine floor 1630A whose height is H1 measured from floor 1601A. On mezzanine floor 1630A, a guard rail 1631A overlooks front door 1612A. A handrail 1622A guards around the perimeter of staircase 1623A on mezzanine floor 1630A.

Next, in FIG. 16B, assume the designer decides to change the overall dimension of house 1610A to W2 and L2 greater than W1 and L1 respectively. Because of method 800 to method 1500 described above, front wall 1602A and its components thereof (not shown) are all enlarged into front wall 1602B. Front door 1612A and its components are automatically expanded into a front door 1612B. Front window 1613A and their components thereof are automatically expanded into a front window 1613B. Front step 1611A now becomes 1611B. This is made possible by smart fitting method 1100, especially by step 1105. All components inside front wall 1602B segmented by window 1641 of CNN 402 are stored and memorized by RNN layer 406. Because all these components are in sequential order, they are automatically changed by step 1105.

Similarly, window 1622A and its components are expanded to 1622B. Mezzanine floor 1630A and its components are automatically expanded into a mezzanine floor 1630B. Guard rail 1631A and its components are automatically expanded to 1631B. A window 1621B is now seen because of the new dimension L2 of side wall 1604B. Window 1621A, window 1622A, side wall 1604A, and back wall 1603A, floor 1601A and their respective components thereof are automatically changed into window 1621B, window 1622A, side all 1604A, back wall 1603B, floor 1601B respectively. On the other hand, the height H1 from the mezzanine floor 1630B is regulated by the local code and cannot be changed. This is realized by step 1114. Table 1641A and its components are not in the sequential order with house 1610A and therefore are not changed. For the same reasons, dining chairs 1642B and 1643B are not changed. This is realized by step 1105.

In FIG. 17C-FIG. 17D, a 2D perspective diagram illustrating a smart fitting and segmentation features of the Recurrent Convolutional Neural Network (RCNN) in of the present invention in accordance with an embodiment of the present invention are illustrated;

In FIG. 17C, a house 1700C spanning in the Y-Z direction of a Cartesian Coordinates 1799 is shown. House 1700C is designed on graphic area 302 of EDI 300. By step 1303 of method 1300, house 1700C is an assembly. RCNN 400 uses feature extraction of RNN layer 406 to memorize all components in house 1700C. This is step 1307 and step 1308. House 1700C includes a floor 1701C, a roof 1702C, a left wall 1703C, a right wall 1704C. Inside of house 1700C, there is a first floor 1720C and a mezzanine 1730C. The first floor 1720C is furnished with a dining table 1751C and a pair of dining chairs 1742C and 1743C. A staircase 1723C leads to mezzanine level 1730C. A horizontal safety handrail 1731C marks the end of mezzanine 1730C. In some aspect of the present invention, the designer can use a cursor 1702 grasping a corner 1701 expanding the length of house 1700C along the Y-direction into a house 1700D as shown in FIG. 17D.

Next referring to FIG. 17D, the height H₁ of house 1700D is unchanged. in accordance with smart fitting method 1400, roof 1702C is automatically changed to a roof 1702CD, horizontal safety handrail 1730C is changed to a longer safety handrail 1730D, and floor 1701C is changed to a longer floor 1701D with a longer width W2. By virtue of method 1400, a staircase 1723D remains the same. Thus, the total area of first floor 1720C is enlarged into a first floor 1730D. A dining table 1741D and a pair of dining chairs 1732D and 1733D are unchanged. The designer can also use cursor 1702 to select dining chair 1742D in a selection window 1740. Method 1100 provides component part list of chair 1720 as shown in FIG. 18A-FIG. 18D below.

Referring next to FIG. 18A-18D, a 3D diagram 1800 demonstrating (a) a CNN filter to search for joints, (b) assembly instructions and bill of materials (BOM), and (c) connectivity between components in accordance with an exemplary embodiment of the present invention is illustrated.

In FIG. 18A, a chair 1830 and its components are shown. Chair 1830 incudes a first stile 1801, a second stile 1802, a first front leg 1803 and its extension 1811, a second front leg 1804 and its extension 1812, aprons 1805-1808, and a pair of cross-rails 1809-1810. A CNN filter 1831 searches for joints between aprons 1805, 1807, and first front leg 1811 as shown in FIG. 18B. CNN filter 1831 is from CNN 402 described above in FIG. 4. RCNN 400 uses CNN layer 402 to break down the components of chair 1830 into components shown in FIG. 18C. Again, CNN 402 searches and detects joints 1820 from each component, e.g., apron 1805 in FIG. 18D. In the end, RCNN 400 generates a bill of materials as shown in FIG. 18C.

Now referring to FIG. 19A, a 3D drawing of two connecting components and their respective joints 1900A is illustrated. As seen components 1900A include a first component j 1910 with a first joint type 1911 coupled to a second component j+1 1920 with a second joint type 1921. This joint type is in the class of T-joint and a dovetail finger joint. The dovetail finger joint includes a female joint 1911 which further comprises a plurality of a fingers 1911-1 arranged next to a plurality of slots 1911-2 into a dovetail shape. Second component j+1 1920 also includes a plurality of complementary slots 1921-1 mated with a plurality of tabs 1911-1 and complementary tabs 1921-2 mated with a plurality of slots 1911-2. When a designer draws first component j 1910 with a first joint type 1911 on graphic area 201, RCNN 400 recommends second component j+1 1920 with second joint type 1921.

Not all components have joints and symmetrical complementary joint as described in FIG. 19A. In FIG. 19B, a 3D drawing of two connecting components and their respective joints 1900B is illustrated. As seen components 1900B include a first component (mortise part) j 1930 with a mortise joint type 1931 coupled to a second component (tenon) j+1 1940 with a tenon joint type 1941. Clearly, this joint type is in the class of T-joint and a special mortise and tenon joint. Tenon part 1930 includes a first square female tenon 1931-1, a round female tenon 1931-2, and a second square female tenon 1931-3. Mortise part 1941 includes a first mortise 1941-1, a nut compartment 1941-2, and a second mortise 1941-3. In connection, first square female tenon 1931-1 is mated with first mortise 1941-1; round female tenon 1931-2 is aligned perfectly with nut compartment 1941-2; and second square female tenon 1931-3 is mated with second mortise 1941-3. A threaded bolt 1951 goes through round female tenon 1931-2 and mated with a nut 1952 situated in nut compartment 1941-2. When a designer draws a tenon j 1930 with tenon joint type 1931 on graphic area 201, RCNN 400 recommends mortise j+1 1940 with mortise joint type 1941. In addition, RCNN 400 also issues a bill of material (BOM) as specified above and assembly instructions. The assembly instructions from RCNN 400 reads as follows: (1) inserting bolt 1952 into nut compartment 1941-2; (2) inserting threaded bolt 1951 into female round tenon 1931-2; (3) connecting tenon 1930 with mortise 1940; (4) using a screw driver to tighten threaded bolt 1941 into nut 1952.

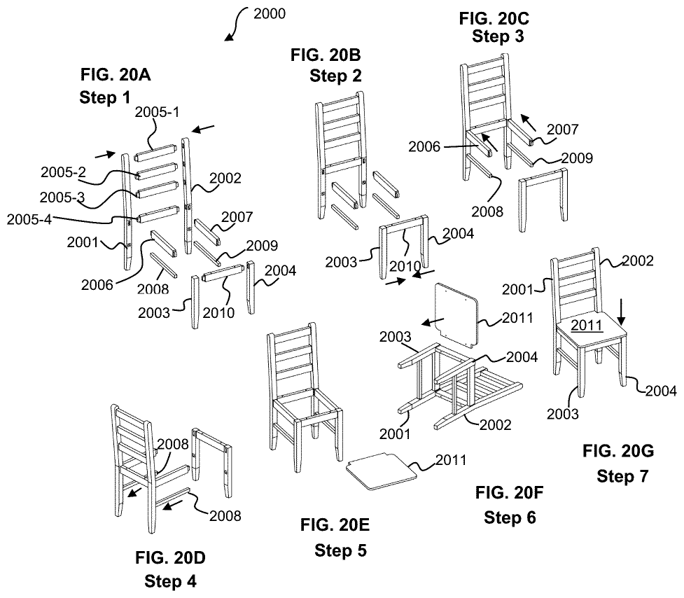

Referring to FIG. 20A-20G, a 3D sequence diagram demonstrating assembly instructions, bill of materials (BOM), and smart manufacturing 2000 in accordance with an embodiment of the present invention is illustrated.

In FIG. 20A, all parts or components of an exemplary chair 250 in FIG. 2 are sequentially designed. These parts are sequentially listed in the following Table 2:

| | | RNN | |
|---|---|---|---|
| Order | Part Name | Memory | Codes |
| 1 | Stile # 1 | 001 | 2001 |
| 2 | Stile #2 | 002 | 2002 |
| 3 | Cross rail #1 | 003 | 20051-1 |
| 4 | Cross rail #2 | 004 | 2005-2 |
| 5 | Cross rail #3 | 005 | 2005-3 |
| 6 | Cross rail # 4 | 006 | 2005-4 |
| 7 | Apron #1 | 007 | 2006 |
| 8 | Apron #2 | 008 | 2007 |
| 9 | Spindle # 1 | 009 | 2008 |
| 9 | Spindle #2 | 010 | 2009 |
| 10 | Stretcher | 010 | 2010 |
| 11 | First leg | 010 | 2003 |
| 12 | Second leg | 010 | 2004 |
| 13 | Seat | 011 | 2011 |

Based on the sequential order associated with memory addresses and geometrical shapes, RCNN algorithms 400 are trained to recognize the connecting order and locations of each component listed in Table 2. In first step of the assembly instructions of FIG. 20A, a first stile 2001 are connected to a second stile 2002 via cross rails 2005-1 to 2005-4. This is because of the male and female connectors of these components. If first stile 2001 and second stile 2002 are connected to aprons 2006-2007 and spindles 2008-2009 first, there would be no room for cross rails 2005-1 to 2005-4 to connect to first stile 2001 and second stile 2002.

Next in FIG. 20B at step 2, for the same reason above, first leg 2003 is connected to second leg 2004 via a stretcher 2010 using male and female joints.

Referring next to FIG. 20C at step 3 and FIG. 20D at step 4, first apron 2006 and second apron 2007 are connected to first stile 2001 and second stile 2002 respectively using male-female joints that are identified by RCNN 400.

In FIG. 20D at step 4, first spindle 2008 and second spindle 2009 are connected to first stile 2001 and second stile 2002 using male-female joints that are identified by RCNN 400.

Finally, in FIG. 20E to FIG. 20G at steps 5, 6, and 7 respectively, after the fame is connected and secured, seat 2011 are finally connected. It is critical to connect first style 2001 and second stile 2002 to cross rails 2005-1 to 2005-4 first. Otherwise, the male joints of cross rails 2005-1 to 2005-4 cannot be connected to female connectors of first stile 2001 and second stile 2002. In other words, female connectors of first stile 2001 and second stile 2002 are blocked if first stile 2001 and second stile 2002 are securely connected to first leg 2003 and second leg 2004 via first apron 2006, second apron 2007, first spindle 2008, and second spindle 2009.

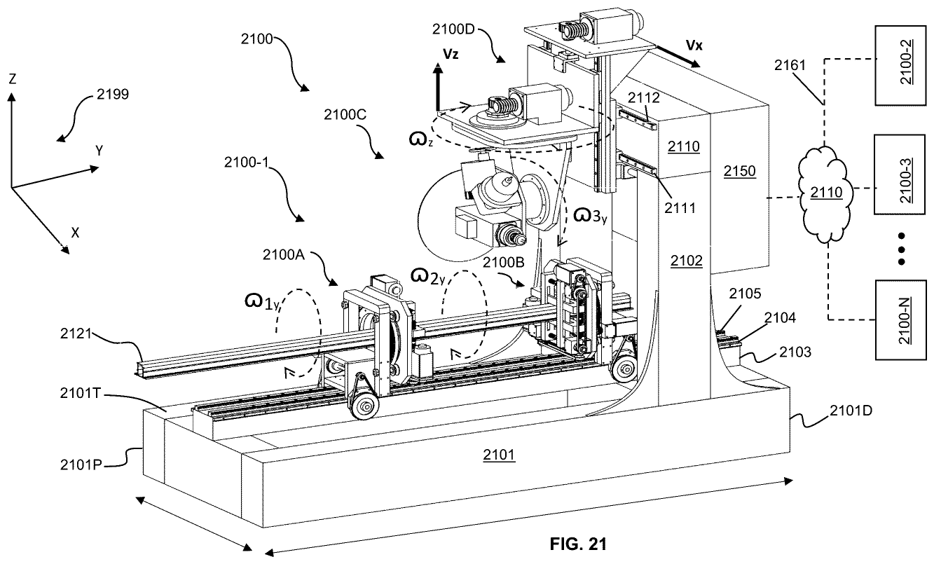

Referring now to FIG. 21, a 3D perspective diagram of a network 2100 in accordance with an embodiment of the present invention is illustrated. Network 2100 includes an omni-direction CNC machine cutting tool 2100-1 and other types of machine cutting tools 2100-2, 2100-3, to . . . 2100-N. Other machine cutting tools 2100-2, 2100-3, to 2100-N may be a mixture of omni-direction CNC machining tools, laser cutters, other types of CNC machining tools, or 3D printers. Omni-direction CNC machine cutting tool 2100-1 includes a first base 2101 spanning along a Y-axis of a XYZ Cartesian coordinate 2199. First base 2101, of length L and width W, includes a proximate end 2101P and a distal end 2101D. On a top surface 2101T of first base 2101, a second base 2102 is firmly erected along a Z-axis near distal end 2101D.

In advantageous embodiments, second base 2102 is shaped like an upside down U-shaped gantry. The legs of the upside down U-shaped gantry spans on the two edges of first base 2101. On top surface 2101T, a workpiece rail support 2103 is deposited substantially at the center of first base 2101 and ran along length L. A pair of a first workpiece rail 2104 and a second workpiece rail 2105 are spun along the edges of workpiece rail support 2103. On top of second base 2102, an X-direction tool head support 2110 is disposed. On the side of X-direction tool head support 2110 along the X-axis, a first X-axis tool head rail 2111 and a second X-axis tool head rail 2112 substantially parallel to first X-axis tool head rail 2111 are laid. A CNC controller 2150 is affixed on the back side of second base 2102 and X-direction tool head support 2110. CNC controller 2150 contains electrical hardware and software that numerically control the entire operation of CNC machining tool network 2100.

Referring again to FIG. 21, a tool head support assembly 2100C is movably connected to X-direction tool head support assembly 2110. Tool head support assembly 2100D carries tool head assembly 2100C. In many aspects of the present invention, tool head support assembly 2100C is designed to move in an omni-direction. In the present disclosure, the omni-direction is defined to include 360° rotations around Z-axis and Y-axis and movements along the X-axis and the Z-axis of XYZ Cartesian coordinate 2199. Tool head assembly 2100C contains various tools that are replaceable for different machining jobs. That is, these tools can be substituted with other tools as required by the design specification. In some advantageous embodiments, different tool heads can be stored and retrieved from a base like a Swiss knife.

Continuing with FIG. 21, a first rotatable clamp 2100A and a second rotatable clamp 2100B are coupled to slide on first workpiece rail 2104 and second workpiece rail 2105. Structurally, first rotatable clamp 2100A and second rotatable clamp 2100B are the same but they are arranged in reversed to each other on first workpiece rail 2104 and second workpiece rail 2105. That is, the back of first rotatable clamp 2100A is set first nearest to proximate end 2101P, while that of second rotatable clamp 2100B is disposed closest to distal end 2101D, resulting in balance and stability to a workpiece 2121. In operation, first rotatable clamp 2100A and second rotatable clamp 2100B operate and rotate independently. More particularly, first rotatable clamp 2100A can hold and move workpiece 2121 along first and second workpiece rails 2104 and 2105 while second rotatable clamp 2100B is in a release state. In many advantageous embodiments of the present invention, first rotatable clamp 2100A and second rotatable clamp 2100B include a four-direction square clamp configured to always hold workpiece 2121 at its center of gravity. In addition, both clamps 2100A and 2100B are designed to rotate 360° around the Y-axis independently. It is noted that more than two workpiece clamps are still within the scope of the present invention. Tool head support assembly 400, tool head assembly 500, first rotatable clamp 2100A, and second rotatable clamp 2100B will be described in details in a continuation patent application No., entitled filed on by the same inventor. This patent application is included herewith by its entirety.

Now referring to FIG. 22, a schematic diagram of a Canum® system 2200 which includes other computer systems and machine cutting tools electrically coupled to a controller box and other user manufacturers via a network in accordance with an exemplary embodiment of the present invention is illustrated. In many embodiments, CNC system 2200 is a personal desktop computer, a laptop, a smart phone, or a tablet. CNC system 2200 includes a controller box 2240 electrically coupled to machine cutting tools 2251-1, 2251-2, . . . , 2251-N and other computers 2221, 2221-1 to 2221-N, 2231, 2232, 2233, 2234, and 2235 via a communication lines 2261 to a network 2210 Controller box 2240 includes, but not limited to, input/output interface 2249, memory 2270, a central processing unit (CPU) 2241, a loop control unit 2250, a display unit 2245, and a power supply unit 2242, all electrically coupled to one another via electrical connections 2262.

In various embodiments of the present invention, controller box 2240 is a printed circuit board (PCB) with electrical connections 2262 are conducting wires such as copper, aluminum, gold, etc. In operation, input/output interface 2249 receive design specifications from clients' communication devices such as smartphones, desktop computers, laptop computers, personal digital assistance (PDA) via network 2210. Communication links 2262 may be wireless such as Cloud network, Bluetooth, 4G, LTE, 5G, Wi-Fi, Zigbee, Z-wave, radio frequency (RF), Near Field Communication (NFC), Ethernet, LoRaWAN. In some embodiments, communication links 2261 is e wired such as RS-232, RS-485, or USB.

Next, the design specification is transferred to CPU/GPU 2241 for translation into software command codes that can numerically control machine cutting tools 2251-1 to 2251-N. The design specification can be generated from CAD (computer aided design) and/or CAM (computer aided machining). The software commands can be G-programming, M programming, automatically programming tool (APT), assembly language, C, C++, or any CNC programming language. The design specification and the software commands are stored in memory 2270. In addition, CPU/GPU 2240 sends the software commands and/or the design specification to be displayed at display unit 2245. In some embodiments, display unit 2245 also displays the current status of any on-going machine work so that workers or operators can view the present machining process. In some other embodiments, input/output interface 2249 can send the current machining work to the display units of the communication devices of the end-users.

Continuing with FIG. 22, CPU/GPU 2241 controls a control loop unit 2250 to control the entire operation loops of CNC machining apparatus 300. A driving system 1111 and CNC machining apparatus 2100 as described in FIG. 21 above are electrically connected to be controlled by control loop unit 354. In various embodiments, a feedback system 1112 which is constituted of sensors 417, 427, 505, 525, 612, 756, and 779, and electrical connections position electrical connections 1003, linear velocity electrical connections 1004, and angular velocity connections 1005. Electrical connections 1003-1005 can be wired such as RS-232, RS-485 and wireless such as Bluetooth, 4G, LTE, 5G, Wi-Fi, Zigbee, Z-wave, radio frequency (RF), Near Field Communication (NFC), Ethernet, LoRaWAN.

Next referring to FIG. 22, a schematic diagram of the CNC network 2200 capable of providing the design work interface 200 and algorithms 100, 500-1500 as described above in FIG. 1 to FIG. 5-FIG. 15 and to operate an array of machine cutting (MC) tools in accordance with an embodiment of the present invention is illustrated. An omni-CNC (“O-CNC”) module 790 includes computer executable instructions which, when executed by server computer 740 performs all manual, auto-mode, and deep learning algorithms such as algorithms 100 of the present invention. O-CNC module 790 includes an auto-mode module 791, deep learning CNN/RNN module 792, coding module 793, CNC controller module 794, a CAD/CAM/CAE module 795, and an application module 796.

In at least one of the various embodiments, while they may be illustrated here as separate modules, auto-mode module 791, deep learning CNN/RNN module 792, coding module 793, CNC controller module 794, application module 795, and data analytics and display module 796 may be implemented as the same module and/or components of the same application. Further, in at least one of the various embodiments, auto-mode module 791, deep learning CNN/RNN 792, coding module 793, CNC controller module 794, a CAD/CAM/CAE module 795, and an application module 796 may be implemented as operating system extensions, modules, plugins, applications, or the likes. In at least one of the various embodiments, auto-mode module 791, deep learning CNN/RNN module 792, coding module 793, CNC controller module 794, application module 795, and data analytics and display module 796 may be implemented as hardware devices such as application specific integrated circuit (ASIC), combinatorial logic circuits, field programmable gate array (FPGA), software applications, and/or the combination thereof.

Referring again to FIG. 22, auto-mode module 791 is configured to provide a final and complete design work by data from various data sources including key-in data, data from clients' existing databases located in group of client computers 721-1, 721-2, . . . , 721-N, at least one client mobile devices 752-1 to 752-N and at least one Machine cutting (MC) tools 751-1 to 751-N. Deep learning CNN/RNN module 792 is configured to detect and classify workpieces. In addition, deep learning CNN/RNN module 792 recommend design work using associative method with past preferences of designers and those designers with the same preferences. Yet, deep learning CNN/RNN module 792 uses sequential analysis of data to provide step-by-step assembly instructions without leaving any connectors and parts unconnected.

Continuing with FIG. 22, after a design work is complete, coding module 793 encodes design work into CAD/CAM models. In addition, coding module 793 also translate the complete design work into M-codes, G-codes, or their variants so as to control Machine cutting (MC) tools 751-1 to 751-N. In the manual mode, CAD/CAM/CAE module 795 allows designers to design using well-known CAD/CAM software programs similar to SolidWorks, CATIA, etc. Still referring to FIG. 7, application module 796 performs all management tasks related to design work interface (EDI) 200 and displays the results on the user's display screen or at least one client mobile devices 732 to 735. In an exemplary implementation of the present invention, power supply 742, network interface 743, ROM/RAM 744, display 745, keyboard 746, audio interface 747, pointing device 748, input/output interface 749, and loop control unit 750 are well-known computer components in the arts and need not be described in details here. It is noted that, non-limiting examples of network 710 include the internet, cloud computing, Software as a service (SaaS), Platform as a service (PaaS), Infrastructure as a service (IaaS), or permanent storage such as optical memory (CD, DVD, HD-DVD, Blue-Ray Discs), semiconductor memory (e.g., RAM, EPROM, EEPROM), and/or magnetic memory (hard-disk drive, floopy-disk drive, tape drive, MRAM) among others.

Continuing with FIG. 22, it will be appreciated that communication channel 2261 may include, but not limited to, short range wireless communication channels, mid range wireless communication channels, and long range wireless communication channels. Wireless short range communication channels include ZigBee™/IEEE 802.15.4, Bluetooth™, Z-wave, NFC, Wi-fi/802.11, cellular (e.g., GSM, GPRS, WCDMA, HSPA, and LTE, etc.), IEEE 802.15.4, IEEE 802.22, ISA100a, wireless USB, and Infrared (IR), LoRa devices, etc. Medium range wireless communication channels in this embodiment of communication link 161 include Wi-fi and Hotspot. Long range wireless communication channels include UHF/VHF radio frequencies. It will be further appreciated that group of client computers 721-1, 721-2, . . . , 721-N, at least one client mobile devices 732-735 and at least one Machine cutting (MC) tools 751-1 to 751-N can be connected together in a master-slave configuration.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

Within the scope of the present description, the reference to “an embodiment” or “the embodiment” or “some embodiments” means that a particular feature, structure or element described with reference to an embodiment is comprised in at least one embodiment of the described object. The sentences “in an embodiment” or “in the embodiment” or “in some embodiments” in the description do not therefore necessarily refer to the same embodiment or embodiments. The particular feature, structures or elements can be furthermore combined in any adequate way in one or more embodiments.

Within the scope of the present description, the word “omni-direction” means all directions of a spherical coordinate covering the same space of the Cartesian XYZ coordinates system 899. The X-direction and Z-direction translational (or linear) movements, the rotational Y-direction and Z-direction of the head tool assembly; the Y-direction translational movements, and the rotation 360° around the Y-axis enable CNC machining apparatus 300 to approach from any angle and operate precisely at any location regardless of the proximity of these points on workpiece 821.

Within the scope of the present description, the words “connected”, “connecting”, “coupled”, “coupling”, “connections”, “coupled”, “bolted”, “laid”, “positioned”, “attached”, “attaching”, “affixed”, “affixing” are used to mean attaching between two described members using screws, nails, tongs, prongs, clips, spikes, staples, pins, male and female nuts, buttons, sleeves, lugs, cams, handles, bars, fasteners, connectors, or the likes.

Within the scope of the present description, the words “connected”, “connecting”, “coupled”, “coupling”, “connections”, “coupled” are used to mean wired and/or wireless connections. Wired connections include electrically conducting wires, cables, lines, coaxial cables, strips, or the likes. Conducting wires are made of conductors such as coppers, aluminum, gold, or the likes. Wireless connections include electromagnetic waves, short range communication channels include ZigBee™/IEEE 802.15.4, Bluetooth™, Z-wave, NFC, Wi-fi/802.11, cellular (e.g., GSM, GPRS, WCDMA, HSPA, and LTE, 5G, etc.), IEEE 802.15.4, IEEE 802.22, ISA100a, wireless USB, and Infrared (IR), LoRa devices, etc. Medium range wireless communication channels in this embodiment of communication link 161 include Wi-fi and Hotspot. Long range wireless communication channels include UHF/VHF radio frequencies.

Within the scope of the present description, the word “network” includes data center, cloud network, or network such as nano network, body area network (BAN), personal area network (PAN), local area network (LAN), campus/corporate area network (CAN), metropolitan area network (MAN), wide area network (WAN), and mesh area networks, or any combinations thereof.

Within the scope of the present description, the word “rotation”, “rotating”, “rotate” includes clockwise and/or counterclockwise direction.

Within the scope of the present invention, the Cartesian XYZ coordinate (x,y,z) also includes equivalent spherical coordinate (r, θ, ϕ), and/or cylindrical coordinate (r, θ, z) that can determine the direction of movement or coordinate of a point of any members of CNC machining apparatus.

### DESCRIPTION OF NUMERALS

200 schematic of a CAD/CAE/CAM with RCNN smart mode
200A design sub-assembly
200B manufacturing sub-assembly
201 interactive graphic screen
210 manual mode CAD/CAE/CAM
211 geometric modeling module
212 engineering analysis module (CAE)
213 design review & evaluation
214 CAD module
220 RCNN based smart mode
221 recommendation module
222 automatic counteraction module
223 smart fitting module
230 database
231 communication link
241 tool & fixture design module
242 NC programming module
243 CAPP module
244 PPC & scheduling
245 network card
251 smart manufacturing module
252 assembly instruction module
260-1 machine cutting tool MC1
260-2 machine cutting tool MC2
260-N machine cutting tool MCN
300 engineering design interface (EDI)
301 graphic area or design area or GUI
302 cursor
311 file menu
311-1 open function
311-2 save function
311-3 save as function
311-4 new file creation function
311-5 import file function
311-N file properties
312 dimension function
313 material function
314 joint (connector)
315 angle
315 color
321 design function
322 edit
323 paint
324 draw function
325 assemble function
326 part assemble instructions
327 rotate function
328 settings
329 options
331 home function
332 machine cutting tool listing
332-1 machine cutting tool listing
332-2 feature listing
333 world wide web access
334 users listing function
335 end function
341 smart mode switch
342 recommendation function
343 forum entering
344 video
345 write function
346 bill of material (BOM)
347 import
348 display auxiliary screen
349 simulation function and analyses
350 design work, e.g., a chair
351 left front leg
351-1 design tool information
352 right front leg
353 left hind leg
354 right hind leg
355 seat
356 stretchers
357 rails
360 auxiliary display screen
361 auxiliary display screen tool bar.
400 RCNN architecture
401 design work input
402 CNN layers
402-1 CNN1 shape
402-2 CNN2 coordinates
402-3 CNN3 dimension
402-4 CNN4 body part
402-5 CNN5 joinery
402-6 CNN6 joint coordinates
403 max pooing layer
404 features
405 FC layers
410 routines that use RCNN outputs
411 smart fitting algorithm
421 assembly semantic
413 smart manufacturing algorithm
414 output layer
500 schematic diagram of RNN architecture
501 input image
402 CNN and max pooling layer
511 first input cell X₀
512 second input cell X₁
513 third input cell X₂
514 fourth input cell X₃
515 fifth input cell X₄
521 first cell state H₀
522 second cell state H₁
523 third cell state H₂
524 fourth cell state H₃
525 fifth cell state H₄
531 first weight Fw
532 second weight Fw
533 third weight Fw
534 fourth weight Fw
535 fifth weight Fw
541 first output cell Y₀
542 second output cell Y₁
543 third output cell Y₂
544 fourth output cell Y₃
551 recommended output
1600 house design work
1610A house design work before change
1601A floor
1602A roof
1603A front wall
1604A back wall
1605A left wall
1611A front step
1612A front door
1613A front window
1622A left wall window
1623A staircase
1630A mezzanine level
1631A mezzanine protecting rail
1641A dining table
1642A first dining chair
1643A second dining chair
1610B house design work before change
1601B floor
1602B roof
1603B front wall
1604B back wall
1605B left wall
1611B front step
1612B front door
1613B front window
1622B left wall window
1623B staircase
1630B mezzanine level
1631B mezzanine protecting rail
1641B dining table
1642B first dining chair
1643B second dining chair
1699 Cartesian Coordinate system
17002D illustration of smart fitting routine
1701 vertex of design work (click and grab point)
1702 cursor
1710A house design work before change
1701A floor
1702A roof
1704A left wall
1720A first floor space
1723A staircase
1730A mezzanine level
1731A mezzanine protecting rail
1741A dining table
1742A first dining chair
1743A second dining chair
1700B 2D house design work after change
1701B floor
1702B roof
1704B left wall
1720B first floor space
1723B staircase
1730B mezzanine level
1731B mezzanine protecting rail
1741B dining table
1742B first dining chair
1743B second dining chair
17992D Cartesian Coordinate system
1800 part list and bill of material (BOM) of a chair
1801 first hind leg
1802 second hind leg
1803 first front leg
1804 second front leg
1805 first stretcher
1806 second stretcher
1807 third stretcher
1808 fourth stretcher
1809 first rail
1810 second rail
1811 front leg left extension
1812 front leg right extension
1820 joint
1830 chair
1831 connection joint
1900A component with dovetail joinery
1910 body section
1911 joinery section
1911-1 tail
1911-2 shoulder
1920 body section of counteraction component
1921 counteraction joint
1921-1 shoulder
1921-2 pin
1900B mortise and tenon joint
1930 body section
1931 joint section
1931-1 square tenon
1931-2 round tenon
1931-3 square tenon
1940 body section
1941 joint section
1941-1 first mortise
1941-2 nut compartment
1941-3 second mortise
1951 screw
1952 nut
2001 Stile #1
2002 Stile #2
2003 First leg
2004 Second leg
2005-1 First cross bar
2005-2 Second cross bar
2005-3 Third cross bar
2005-4 Fourth cross bar
2006 Apron #1
2007 Apron #2
2008 Spindle #1
2009 Spindle #2
2010 stretcher
2011 Seat
2100 network
2100A first rotatable clamp
2100B second rotatable clamp
2100-2 second machine cutting tool
2100-3 third CNC machining cutting tool
2100-N Nth machine cutting tool
2101 first base
2101P proximate end of the first base
2101D distal end of the first base
2101T top surface of the first base
2102 second base perpendicular to the first base
2103 workpiece rail support
2104 first workpiece rail
2105 second workpiece rail
2110 X-direction tool head support
2111 first X-direction tool head rail
2112 second X-direction tool head rail
2121 workpiece
2150 CNC controller box
2199 Cartesian coordinate system
2100D tool head support assembly
2200 Canum® CAD/CAM/CAE network
2221 first computer installed with Canum® software
2221-1 second computer installed with Canum® software
2221-N nth computer installed with Canum® software
2231 first laptop computer installed with Canum® software
2232 second laptop computer installed with Canum® software
2241 CPU/GRU
2242 power supply
2243 network interface
2244 ROM/RAM
2245 display unit
2246 keyboard
2247 audio interface
2248 pointing device
2249 I/O interface
2250 loop control unit
2270 memory
2271 Operating system
2272 BIOS
2280 data storage
2281 test dataset
2282 training dataset
2290 Canum module
2291 CAD/CAM/CAE software
2292 RCNN based smart mode
2293 automatic counteraction module
2294 smart fitting module
2295 RCNN module
2296 NC programming unit
2297 smart manufacturing module

What is claimed is:

1. A computer software program stored in a non-transitory memory device when executed by at least one processing units, said computer software program is operative to perform the following steps:
(a) receiving an design work in a graphic design interface;
(b) if said design work is not completed, then using a recommendation system based on convolutional neural network (CNN) to complete said design work;
(c) using recurrent neural network (RNN) to create a step-by-step assembly instructions for said completed design work so as every connection of said design work is fulfilled; and
(e) assigning either said components or said completed design work specification to be realized by at least one array of computerized numerical control (CNC) machining tool in an array of CNC machining tools via a network.

2. The computer software program of claim 1, wherein said step (a) further comprises manually designing each of said components of said design work using a computer aided engineering (CAE) module.

3. The computer software program of claim 2, wherein said manually drawing components of said design work further comprises providing parameters for each of said components that include dimension, material, color, an angle of connection, a connection type, and a plane surface between said components that are connected together.

4. The computer software program of claim 3 further comprising if said design work is completed, assigning identification codes and connection codes to each of said components of said completed design work so as to assist said RNN to map out the assembly instructions of each of said components.

5. The computer software program of claim 4, wherein when connectors of a particular component are missing, using an engineering modeling module to calculate connectors that best fits said particular component with linking components which are connected to said particular component.

6. The computer software program of claim 4 wherein when said dimension of said particular component is not provided, using said auto-mode to measure the dimension where said particular component to be connected to said linking components, then assigning said dimension to said particular component and insert said particular component to said linking components.

7. The computer software program of claim 1, wherein said step (b) of receiving an design work further comprises importing components of said design work specification in said design area from a database.

8. The computer software program of claim 1, wherein said step (b) of receiving an design work specification further comprises importing images of said components of said design work specification on said design area from a social media.

9. The computer software program of claim 8 further comprising using said CNN algorithms to recognize said images of said components and then convert said images into said design work.

10. The computer software program of claim 1 wherein said step (b) further comprises:
classifying said design work;
using feature filters in said CNN to detect said missing components; and
using association algorithm to recommend said missing components.

11. The computer software program of claim 1 wherein said step (c) further comprises: using said component codes, said connection codes, memory spaces configured to store said components and said connector types, geometrical shapes of said components and connector types to produce said step-by-step assembly instructions for said design work.

12. A computer system, comprising:
a CNC module operative to provide a graphic design interface configured to receive an design work of a workpiece and to provide machine codes which are used to control an array of computerized numeric control (CNC) machine tools to manufacture said workpieces, wherein said CNC module is further configured to complete said design work using a convolutional neural network (CNN);
at least one processing units electrically coupled to operate said CNC module; and
a memory device operative to store said CNC module and a dataset whereby, wherein said CNC module is configured to use deep learning algorithms to automatically complete said design work using said CNN and to provide step-by-step assembly instructions of said design work using a feature detection of a recurrent neural network (CNN).

13. The computer system of claim 12 wherein said CNC module further comprises:
an auto-mode module configured to fit components into a partially complete design work;
a recommendation system using deep learning algorithms configured to recommend missing components, connectors, and/or an entirety of said design work based on inputs of a user;
an assembling instruction module using said deep learning algorithms to provide step-by-step assembling instructions of said design work; and
a CNC control module configured to assign said components of said design work to.

14. The computer system of claim 13 further comprises:
an application control module configured to generate and manage said design work interface; and
a communication module configured to manage communication between users who are connected with said computer system via a network.

15. The computer system of claim 14 further comprises:
an engineering modeling module configured to provide machine codes for each of said components; and
an design work aid (EDA) module configured to enable said users to manually design said design work.

16. The computer system of claim 12 wherein said recommendation system further comprises: a convolutional neural network (CNN) configured to:
classifying said design work;
using feature filters in said CNN to detect said missing components; and
using association algorithm to recommend said missing components.

17. The computer software program of claim 1 wherein assembly construction module further comprises a recurrent neural network (RNN) configured to use said component codes, said connection codes, memory spaces configured to store said components and said connector types, geometrical shapes of said components and connector types to produce said step-by-step assembly instructions for said design work.

18. The computer system of claim 12 wherein said array of Machine cutting (MC) tools comprises omni-direction Machine cutting (MC) tools, each comprising:
a first base having a top side, a bottom side, a width, and a length having a proximate end and a distal end, wherein said length spans along a Y-axis of a 3 dimension (3D) Cartesian orthogonal coordinate system further having a X-axis and a Z-axis;
a second base vertically erected in said Z-axis and on said top surface at said distal end and perpendicular to said first base;
a tool head support assembly having a tool head, connected to and move a tool head in an omni direction; and
a plurality of rotatable clamps configured to independently hold, release, and move a workpiece along said Y-axis and independently rotate a workpiece 360° around said Y-axis.

19. The computer system of claim 16 wherein said tool head support assembly further comprises:
(a) a first linear movement in said Z axis;
(b) a second linearly movement in said X axis;
(c) a first rotational movement in 360° around said Z axis; and
(d) a second rotational movement in 360° around said Y-axis.

20. The computer system of claim 17 wherein each of said plurality of rotatable clamps further comprises:
a transport assembly configured to move linearly along said Y-axis;
a rotation assembly, mechanically coupled to said carrier assembly, configured to rotate 360° around said Y-axis; and
a clamping assembly, mechanically coupled to said rotation assembly, configured to clamp said workpiece from four directions.
